(19) United States
(12) Patent Application Publication
(10) Pub. No.: US 2016/0329675 A1
(43) Pub. Date: Nov. 10, 2016

(54) ELECTRIC WIRE PROCESSING DEVICE AND WIRING MODULE PRODUCTION METHOD

(71) Applicant: SUMITOMO WIRING SYSTEMS, LTD., Yokkaichi-shi (JP)

(72) Inventor: Hideoki HORIKI, Mie (JP)

(73) Assignee: SUMITOMO WIRING SYSTEMS, LTD., Mie (JP)

(21) Appl. No.: 15/108,145

(22) PCT Filed: Dec. 26, 2014
(86) PCT No.: PCT/JP2014/084463

§ 371 Date: Jun. 24, 2016

(30) Foreign Application Priority Data
Jan. 9, 2014 (JP) 2014-002145

(51) Int. Cl. H01R 43/20; H01R 43/055; H01R 43/052

(52) U.S. Cl. CPC H01R 43/20; H01R 43/052; H01R 43/055

(57) ABSTRACT

An electric wire processing device includes: a wire end holding unit; a movement wire end holding unit for holding a portion of an end of a terminal-attached electric wire that is not included in the portion held by the wire end holding unit; a wire end moving mechanism for moving the movement wire end holding unit between a position at which the movement wire end holding unit can hold the end of the terminal-attached electric wire held by the wire end holding unit, and another position; and a terminal correcting unit. The terminal correcting unit pinches the terminal at the end of the terminal-attached electric wire held by the wire end holding unit so that the orientation of the terminal is corrected to a predetermined orientation when the end of the terminal-attached electric wire is transferred from the end holding unit to the movement wire end holding unit.

### TECHNICAL FIELD

The present invention relates to a technique for holding an end of a terminal-attached electric wire, and in particular relates to a technique suitable for inserting a terminal into a connector.

### BACKGROUND ART

Patent Document 1 discloses a terminal insertion device that includes a housing holding unit, an insertion unit, and a control unit. The housing holding unit is configured to be capable of holding a connector housing so that it can move in horizontal and vertical directions. The insertion unit is configured to insert terminal fittings attached to electric wires into terminal accommodating chambers of the connector housing.

### CITATION LIST

### Patent Document

Patent Document 1: JP 2009-64722A

### SUMMARY OF INVENTION

### Technical Problem

However, in the technique disclosed in Patent Document 1, there may be a case where a terminal fitting is not held at a predetermined position and orientation with respect to the insertion unit. In this case, even if the insertion unit attempts to insert the terminal fitting into a predetermined terminal accommodating chamber of the connector housing, the positions of the terminal fitting and the terminal accommodating chamber will be shifted, and the terminal fitting will collide against the connector housing in the vicinity of the opening of the terminal accommodating chamber. Accordingly, insertion of the terminal fitting may be unsuccessful.

Therefore, it is an object of the present invention to enable a terminal to be inserted into a cavity of a connector more reliably.

### Solution to Problem

In order to solve the above-described problem, according to a first aspect, an electric wire processing device for holding and moving a terminal at an end of a terminal-attached electric wire, includes: a wire end holding unit for holding the end of the terminal-attached electric wire; a movement wire end holding unit for holding a portion of the end of the terminal-attached electric wire that is not included in the portion held by the wire end holding unit; a wire end moving mechanism for moving the movement wire end holding unit between a position at which the movement wire end holding unit can hold the end of the terminal-attached electric wire held by the wire end holding unit, and another position; and a terminal correcting unit including a pair of pinching parts for pinching the terminal, the pair of pinching parts pinching the terminal at the end of the terminal-attached electric wire held by the wire end holding unit so that the orientation of the terminal is corrected to a predetermined orientation when the end of the terminal-attached electric wire is transferred from the wire end holding unit to the movement wire end holding unit.

According to a second aspect, the electric wire processing device according to the first aspect is such that the pair of pinching parts pinch a conductor-crimped part, which is crimped to a conductor of the electric wire, of the terminal.

According to a third aspect, the electric wire processing device according to the first or second aspect is such that the terminal correcting unit includes an elastic supporting part for supporting at least one of the pair of pinching parts so that that pinching part is displaceable with respect to a direction in which the pair of pinching parts perform pinching.

According to a fourth aspect, the electric wire processing device according to any one of the first to third aspects is such that one of the pair of pinching parts of the terminal correcting unit is supported so as to be movable together with the movement wire end holding unit, and when the movement wire end holding unit is moved toward the wire end holding unit by the wire end moving mechanism, said one of the pair of pinching parts approaches the wire end holding unit, so that the terminal is pinched between the pair of pinching parts.

According to a fifth aspect, the electric wire processing device according to any one of the first to fourth aspects further includes: a connector supporting unit for holding a connector; a terminal insertion mechanism including the movement wire end holding unit and the wire end moving mechanism, the terminal insertion mechanism transporting and inserting the end of the terminal-attached electric wire into a cavity of the connector via the movement wire end holding unit.

According to a sixth aspect, a wiring module production method in which a terminal at an end of a terminal-attached electric wire is inserted into a cavity of a connector, includes: a step (a) of holding the end of the terminal-attached electric wire with a wire end holding unit; a step (b) of pinching the terminal at the end of the terminal-attached electric wire held in the step (a), and correcting the orientation of the terminal to a predetermined orientation; a step (c) of holding a portion of the terminal at the end of the terminal-attached electric wire that is not included in the portion held by the wire end holding unit while the terminal is pinched in the step (b), and transferring the end of the terminal-attached electric wire from the end holding unit to the movement wire end holding unit; and a step (d) of inserting the end of the terminal-attached electric wire held in the step (c) in this orientation into the cavity of the connector.

### Advantageous Effects of the Invention

According to the first aspect, the terminal is pinched by a pair of pinching parts so that the orientation of the terminal at an end of the terminal-attached electric wire held by the electric wire end holding unit is corrected to a predetermined orientation when the end of the terminal-attached electric wire is transferred from the wire end holding unit to the movement wire end holding unit, and thus it is possible to hold the terminal by the movement wire end holding unit preferably in a predetermined orientation.

Since the conductor-crimped part of the terminal is flat and is crimped to the conductor, an excellent strength is also achieved. Accordingly, by pinching the conductor-crimped part by the terminal correcting unit as with the second aspect, it is possible to reliably correct the orientation of the terminal to a predetermined orientation while suppressing the deformation of the terminal.

According to the third aspect, since at least one of the pair of pinching parts is displaceably supported by the elastic supporting part, it is possible to suppress an excessive pinching force with respect to the terminal, and to suppress the deformation of the terminal.

According to the fourth aspect, the terminal is pinched by the pair of pinching parts by the operation of the wire end moving mechanism of the movement wire end holding unit, making it possible to simplify the configuration thereof.

According to the fifth aspect, since the terminal can be inserted into the cavity while the terminal is held preferably in a predetermined orientation, it is possible to suppress an error in the insertion of the terminal.

### BRIEF DESCRIPTION OF DRAWINGS

FIG. 1 is a perspective view schematically illustrating a terminal insertion device according to an embodiment.

FIG. 2 is a plan view schematically illustrating the terminal insertion device.

FIG. 3 is a plan view schematically illustrating the terminal insertion device that performs an operation position shift process.

FIG. 4 is a plan view schematically illustrating the terminal insertion device that performs a clamping start process.

FIG. 5 is a plan view schematically illustrating the terminal insertion device that performs a first transport primary process.

FIG. 6 is a plan view schematically illustrating the terminal insertion device that performs a first transport secondary process.

FIG. 7 is a plan view schematically illustrating the terminal insertion device that performs a first transfer process.

FIG. 8 is a plan view schematically illustrating the terminal insertion device that performs a second transport process.

FIG. 9 is a plan view schematically illustrating the terminal insertion device that performs a second transfer process.

FIG. 10 is a plan view schematically illustrating the terminal insertion device that performs a third transport process.

FIG. 11 is a plan view schematically illustrating the terminal insertion device that performs a third transfer process.

FIG. 12 is a plan view schematically illustrating the terminal insertion device that performs a fourth transport primary process.

FIG. 13 is a plan view schematically illustrating the terminal insertion device that performs a fourth transport secondary process.

FIG. 14 is a plan view illustrating ends of terminal-attached electric wires that are attached to a wire arraying member.

FIG. 15 is a diagram schematically illustrating a wiring module.

FIG. 16 is a perspective view schematically illustrating a terminal correcting unit included in a first clamping unit-associated mechanism.

FIG. 17 is a diagram illustrating an operation of the terminal correcting unit.

FIG. 18 is a diagram taken along the line XVIII-XVIII of FIG. 17.

FIG. 19 is a diagram illustrating an operation of the terminal correcting unit.

FIG. 20 is a diagram taken along the line XX-XX of FIG. 19.

FIG. 21 is a diagram illustrating an operation that is performed when a terminal is rolled.

### DESCRIPTION OF EMBODIMENTS

Hereinafter, an embodiment will be described with reference to the accompanying drawings. The embodiment below is an example in which the present invention is embodied, and does not restrict the technical scope of the present invention.

### Terminal Insertion Device

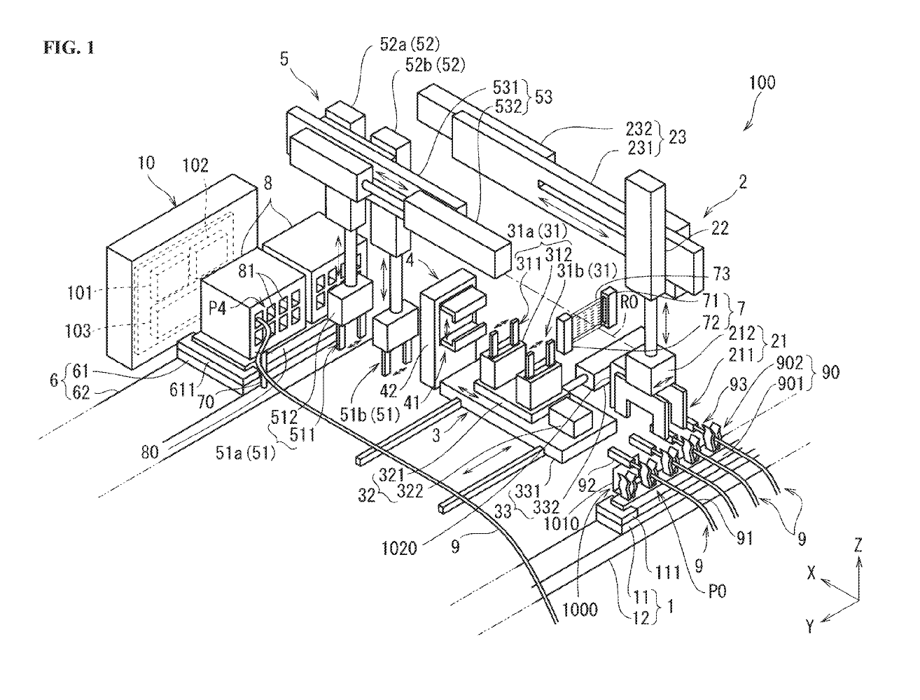

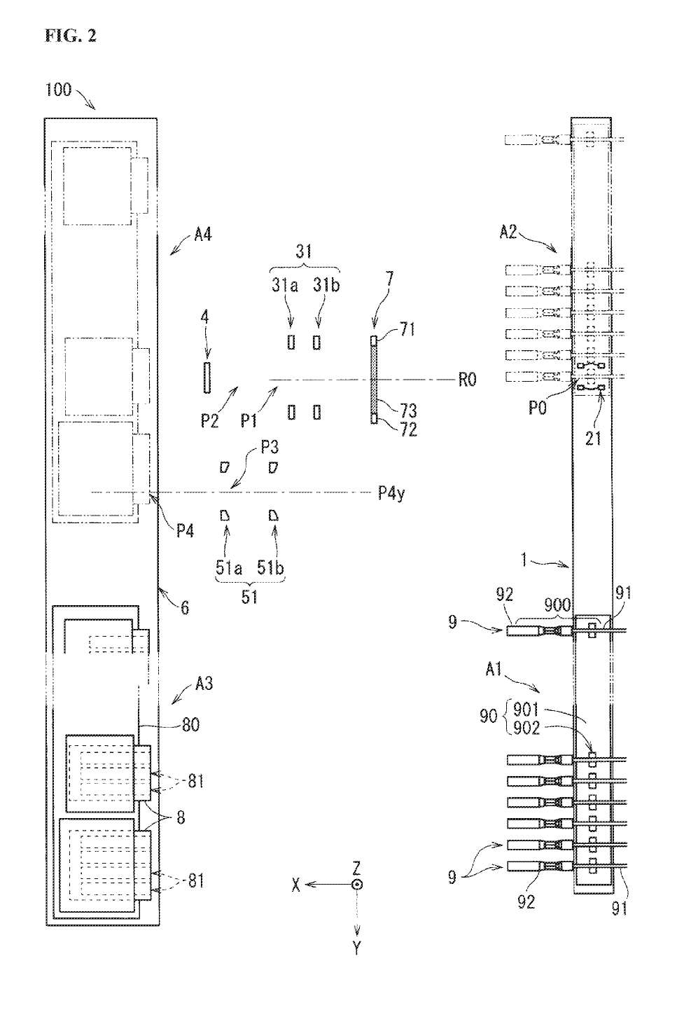

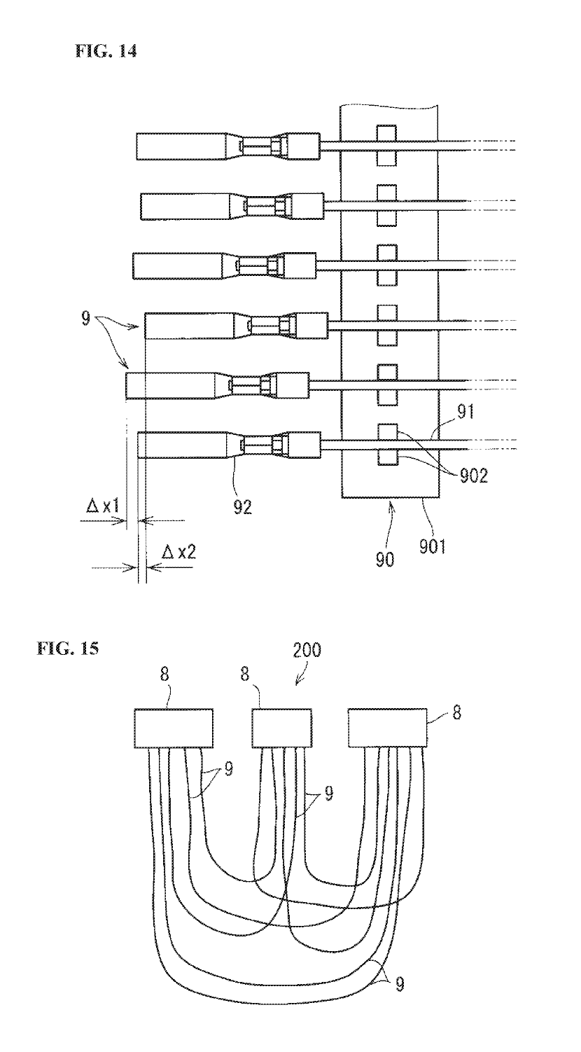

The overall configuration of a terminal insertion device 100 according to an embodiment will first be described with reference to FIGS. 1 and 2. The terminal insertion device 100 is a device for producing a wiring module 200 (see FIG. 15) that includes at least one terminal-attached electric wire 9 and at least one connector 8, by inserting a terminal 92 at an end of the terminal-attached electric wire 9 (i.e. an electric wire 9 to which a terminal is attached) into a cavity 81 of the connector 8. Particularly, the terminal insertion device 100 of the present embodiment is a device for producing a wiring module 200 that includes a plurality of terminal-attached electric wires 9 and a plurality of connectors 8. Note that the wiring module 200 may be configured as a wire harness for electrical wiring in a vehicle or the like by being bundled alone in a shape conforming to a wiring path of the vehicle. Alternatively, the wiring module 200 may be configured as a wire harness for electrical wiring in a vehicle or the like by being bundled in combination with another wiring module and at least one of its electric wires in a shape conforming to a wiring path of the vehicle.

Note that in the present embodiment, description will be given taking an example in which an electric wire processing device is included in the terminal insertion device 100, but the present electric wire processing device is applicable to various devices that transfers and moves an end of a terminal-attached electric wire 9 so as to subject it to suitable processing. Of course, the present electric wire processing device relates to a technique for holding a terminal 92 preferable in a constant orientation, and thus it is appropriate that the present electric wire processing device is included in a device for inserting a terminal 92 into a cavity 81 of a connector 8.

Note that, for convenience, illustrations of the constituent components do not necessarily match each other between FIGS. 1 and 2 in details such as the shape and the size. Furthermore, in FIG. 2, illustrations of some mechanisms shown in FIG. 1 are omitted.

The terminal insertion device 100 is provided with a wire arraying member transport mechanism 1, terminal insertion mechanisms 2 to 5, a connector arraying member transport mechanism 6, a light sensor 7, and a control unit 10. The terminal insertion mechanisms 2 to 5 include a first clamping unit-associated mechanism 2, a second clamping unit-associated mechanism 3, a third clamping unit 4, and a fourth clamping unit-associated mechanism 5.

Hereinafter, the overall configuration of the terminal insertion device 100 will be described, and then a description will be given with focus on a configuration for correcting the orientation of a terminal 92 when the end of the terminal-attached electric wire 9 is transferred.

### Terminal-Attached Electric Wire

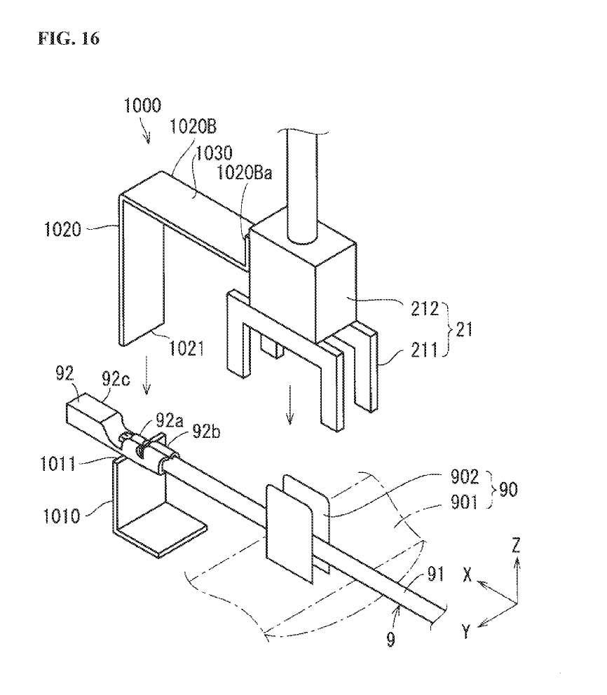

Each terminal-attached electric wire 9 includes an electric wire 91 and terminals 92 connected to the ends of the electric wire 91. The electric wire 91 is an insulated electric wire that includes a linear conductor and an insulating coating covering the circumference of this conductor. The terminal 92 is an electrically conductive member made of metal or the like. The terminal 92 of the present embodiment is a crimp-type terminal, and has a conductor-crimped part 92a, which is crimped to the conductor of the electric wire 91, a coating-crimped part 92b, which is crimped to a portion of insulating coating of the electric wire 91, and a connection part 92c, which is to be connected to a counterpart terminal (see FIG. 16).

The shape of the conductor-crimped part 92a and the coating-crimped part 92b before crimping is a U-shape, and the conductor-crimped part 92a is crimped to the conductor and the coating-crimped part 92b is crimped to the insulating coating by plastically deforming both ends of each crimped part inwardly in a state in which a part of the conductor or the insulating coating is arranged on the bottom thereof. In the crimped state, the conductor-crimped part 92a and the coating-crimped part 92b have a shape in which a pair of semicircle parts are arranged on the flat or gently curved bottom so as to be adjacent to each other, with the conductor or the insulating coating embraced and supported therebetween. Both the conductor-crimped part 92a and the coating-crimped part 92b have a flat cross sectional shape as a whole, and thus by clamping the conductor-crimped part 92a or the coating-crimped part 92b with a suitable member, it is possible to correct the orientation of the direction of the flat shape to a direction orthogonal to the clamping direction.

Note that it is after the case where the connection part 92c has the shape of a tubular (for example, square tubular) male terminal, or the shape of a flat plate-like or pin-like male terminal.

### Connector

Each connector 8 is a member having a plurality of cavities 81 for accommodating the terminals 92 of the terminal-attached electric wires 9. The main portion of the connector 8 that forms its outer shape is a non-conductive member that is made of for example, a synthetic resin such as polypropylene (PP), polyethylene (PE), polyvinyl chloride (PVC), polyethylene terephthalate (PET), or polyamide (PA). Furthermore, the connector 8 may include, in its main portion, not-shown busbars that get into contact with the terminals 92 of the terminal-attached electric wires 9 that are inserted into the cavities 81.

The connector 8 is provided with the cavities 81 into which the terminals 92 can be inserted and that are arrayed in a predetermined configuration. Each cavity 81 is provided with a lance or the like serving as an engagement structure for retaining and engaging with a terminal 92, and when the terminal 92 is inserted into the cavity 81, the lance or the like retains and engages with the terminal 92, whereby the terminal 92 is held in the cavity 81.

If, for example, the terminal 92 is rotated about its axis when being inserted into the cavity 81, a situation may occur in which the terminal 92 is caught on the protruding lance, an engagement member of a retainer, or the like in the cavity 81 on the way of the insertion in the cavity 81. Therefore, by keeping the terminal 92 preferably in a predetermined orientation that is suitable for insertion into the cavity 81, it is possible to insert the terminal 92 into the cavity 81 smoothly and more reliably.

### Wire Arraying Member Transport Mechanism

The wire arraying member transport mechanism 1 is a mechanism for moving a wire arraying member 90 while holding it so that it can be removed. The wire arraying member 90 has an elongated base portion 901 and a plurality of wire retaining portions 902 protruding from the base portion 901. Each wire retaining portion 902 includes a pair of members that clamp and retain, with their elastic force, a portion of the electric wire 91 of the terminal-attached electric wire 9 that is close to the terminal 92.

The plurality of wire retaining portions 902 are formed on the base portion 901 so as to be lined up in a line. Furthermore, the wire retaining portions 902 of the wire arraying member 90 respectively clamp and retain the electric wires 91 of the terminal-attached electric wires 9 in a state in which the front ends of the terminals 92 of the terminal-attached electric wires 9 point in the same direction. The direction in which the wire retaining portions 902 are lined up is a direction that is orthogonal to the direction in which the front ends of the terminals 92 of the terminal-attached electric wires 9 point.

For example, the pairs of members of the wire retaining portions 902 are themselves elastically deformable members, and clamp and retain the electric wires 91 with the elastic force generated by the elastic deformation. Alternatively, the pairs of members of the wire retaining portions 902 may be subjected to an elastic force in a direction in which the members of each pair approach each other by not-shown elastic bodies such as springs.

Ordinarily, the terminals 92 are connected to both ends of the terminal-attached electric wires 9 retained by the wire arraying member 90. Also, the wire arraying member 90 supports the portions of the electric wires 91 at both ends of the plurality of terminal-attached electric wires 9 using the wire retaining portions 902. Accordingly, the wire arraying member 90 clamps the electric wires 91 at twice as many positions as there are terminal-attached electric wires 9, using the wire retaining portions 902.

The wire retaining portions 902 are used as wire end holding units for holding ends of terminal-attached electric wires 9 and performing transfer, at the time of correction of the orientation of the terminal 92 when an end of a terminal-attached electric wire 9 is transferred, as will be described later.

The wire arraying member transport mechanism 1 is provided with a fixing seat 11 and a linear actuator 12. The fixing seat 11 is a portion for holding the wire arraying member 90 so that it can be removed. The fixing seat 11 is provided with a wire arraying member locking mechanism 111 that has a structure of capable of holding the wire arraying member 90 and releasing the holding. For example, a well-known locking mechanism capable of holding a counterpart member with an engagement structure and releasing the holding may be employed as the wire arraying member locking mechanism 111.

Note that in FIG. 2, an illustration of the wire arraying member locking mechanism 111 is omitted.

In the description below, the direction in which the front ends of the terminals 92 of the terminal-attached electric wires 9 supported by the wire arraying member 90 point while the wire arraying member 90 is held on the fixing seat 11 is referred to as “first direction”. In the present embodiment, the first direction is the horizontal direction.

Furthermore, a direction that is along the direction in which the wire retaining portions 902 are lined up while the wire arraying member 90 is held on the fixing seat 11 is referred to as “second direction”. The second direction is orthogonal to the first direction. In the present embodiment, the second direction is also the horizontal direction. In the coordinate axes of the drawings, the positive X-axis direction is the first direction, and the positive Y-axis direction is the second direction.

Accordingly, the fixing seat 11 holds the wire arraying member 90 in a state in which the front ends of the terminals 92 of the terminal-attached electric wires 9 supported by the wire arraying member 90 point in the first direction, and the direction in which the wire retaining portions 902 are lined up is along the second direction, which is orthogonal to the first direction.

The linear actuator 12 moves the fixing seat 11 in the second direction, that is, in the Y-axis direction. By moving the fixing seat 11 in the second direction, the linear actuator 12 selectively positions the wire retaining portions 902 of the wire arraying member 90 at a predetermined start position P0. The linear actuator 12 is, for example, a well-known ball screw-type electric actuator or the like.

In the state in which the wire arraying member 90 is held on the fixing seat 11, the positions of the respective wire retaining portions 902, that is, the positions of the respective electric wires 91 retained by the wire retaining portions 902 are known. For example, it is conceivable that the plurality of wire retaining portions 902 are lined up in a line at equal intervals from the reference position of the fixing seat 11. In this case, if an ordinal number indicating the position of a target wire retaining portion 902 from an end is designated, then the amount by which the linear actuator 12 needs to be operated to move the target wire retaining portion 902 and the electric wire 91 retained thereby to the start position P0 (the direction and distance in which the fixing seat 11 is transported) will be defined.

As shown in FIG. 2, the wire arraying member transport mechanism 1 can move the wire arraying member 90 in the first direction in a range from a first waiting position Al, at which the entire wire arraying member 90 is away from the start position P0, to a first operation position A2, at which a part of the wire arraying member 90 is located at the start position P0.

The wire arraying member 90 supporting the ends of the plurality of terminal-attached electric wire 9, that is, a module of the wire arraying member 90 is prepared for, for example, each wiring module 200.

In a process that is performed prior to the process that is performed by the terminal insertion device 100, the respective ends of the terminal-attached electric wires 9 are fixed to the wire retaining portions 902 of the wire arraying member 90 using a manual operation or another device. Then, the module of the wire arraying member 90 is delivered from a position at which the other process was performed to the place of the terminal insertion device 100, and is mounted on the wire arraying member transport mechanism 1.

FIG. 14 is a plan view illustrating the ends of the terminal-attached electric wires 9 that are retained by the wire arraying member 90. As shown in FIG. 14, in the module of the wire arraying member 90, the positions at which the wire retaining portions 902 respectively clamp the electric wires 91 of the terminal-attached electric wires 9 may vary. Δx1 and Δx2 of FIG. 14 denote variations in the lengths of the portions of the ends of the terminal-attached electric wires 9 that are protruding from the wire retaining portion 902.

A variation in the positions at which the wire retaining portions 902 respectively clamp the electric wires 91 of the terminal-attached electric wires 9 is caused by, for example, a variation in the process in which the ends of the terminal-attached electric wire 9 are fixed to the wire retaining portions 902, or by a misalignment due to external forces applied to the terminal-attached electric wires 9 during the delivery of the wire arraying member 90.

The variation in the positions at which the wire retaining portions 902 respectively clamp the electric wires 91 becomes a variation in the position of the end of the terminal-attached electric wire 9 that is positioned at the start position P0 by the wire arraying member transport mechanism 1. Furthermore, a variation in the positions of the electric wires 91 in the depth direction of the wire retaining portions 902 is also conceivable. Furthermore, there may be cases where, depending on a variation in accuracy of connection of the terminal 92 to the end of the electric wire 91, the terminal 92 may slightly be inclined with respect to the longitudinal direction of the electric wire 91. Also such a variation in the inclination may cause a variation in the positions of the terminals 92.

As will be described later, the terminal insertion device 100 has a function of correcting such a variation in the position of the end of the terminal-attached electric wire 9 before the terminal 92 of the terminal-attached electric wire 9 reaches the cavity 81 of the connector 8.

In the description below, a region of each terminal-attached electric wire 9 from the terminal 92 to a portion of the electric wire 91 that is close to the terminal 92 is referred to as an “end region 900”.

### Connector Arraying Member Transport Mechanism

The connector arraying member transport mechanism 6 is a mechanism for moving a connector arraying member 80 while holding it so that it can be removed. The connector arraying member 80 has a not-shown holding mechanism for holding the plurality of connectors 8 in a state in which each connector 8 can be removed.

The connector arraying member 80 supports the plurality of connectors 8 in a state in which they are lined up in at least one line. In the examples shown in FIGS. 1 and 2, the connector arraying member 80 supports the plurality of connectors 8 in the state in which they are lined up in one line. However, it is conceivable that the connector arraying member 80 supports the plurality of connectors 8 that are stacked on one another in two or more stages and are lined up in one line on each stage.

The connector arraying member 80 supports the plurality of connectors 8 in a state in which the entrances of the cavities 81 thereof face in the same direction. More specifically, the connector arraying member 80 supports the plurality of connectors 8 in the state in which the entrances of the cavities 81 of the plurality of connectors 8 face in the same direction and the direction in which the connectors 8 are lined up is orthogonal to the direction in which the entrances of the cavities 81 face.

The connector arraying member transport mechanism 6 is provided with a fixing seat 61 and a linear actuator 62. The fixing seat 61 is a portion for holding the connector arraying member 80 so that it can be removed. The fixing seat 61 is provided with a connector arraying member locking mechanism 611 that has a structure that is capable of holding the connector arraying member 80 and releasing the holding. For example, a locking mechanism similar to the wire arraying member locking mechanism 111 is employed as the connector arraying member locking mechanism 611.

The fixing seat 61 holds the connector arraying member 80 so that is can be removed, in a state in which the plurality of connectors 8 supported by the connector arraying member 80 are lined up in a direction parallel to the direction in which the wire retaining portions 902 are lined up. In this case, the fixing seat 61 holds the connector arraying member 80 in the state in which the plurality of connectors 8 are lined up in the second direction, and the entrances of the cavities 81 of the plurality of connectors 8 face in a direction opposite to the first direction (the negative X-axis direction).

This fixing seat 61 serves as a connector supporting unit for holding the connectors 8 when the terminals 92 are inserted into the cavities 81 of the connectors 8.

Note that in the example shown in FIG. 2, although the fixing seat 61 of the connector arraying member 80 has a structure in which the connectors 8 are fitted therein, an illustration of this structure is omitted in FIG. 2. Furthermore, in FIG. 2, an illustration of the connector arraying member locking mechanism 611 is also omitted.

The linear actuator 62 moves the fixing seat 61 in the second direction, that is, the Y-axis direction. By moving the fixing seat 61 in the second direction, the linear actuator 62 selectively positions a cavity 81 of the connector 8 supported by the connector arraying member 80 at a predetermined end position P4. The linear actuator 62 is, for example, a well-known ball screw-type electric actuator or the like.

The end position P4 is a position in the second direction. The end position P4 is a position that is aligned, in the second direction, with a third intermediate position P3, which will be described later. In other words, the coordinate P4y in the second direction representing the end position P4 corresponds to the coordinate of the third intermediate position P3 in the second direction.

In the state in which the connector arraying member 80 is held on the fixing seat 61, the positions of the cavities 81 of the connectors 8 are known. The positions of the cavities 81 on the connector arraying member 80 are determined by the position of each connector 8 on the fixing seat 61, and the specification of the shape of the connector 8.

For example, in the control unit 10, identification codes of the cavities 81 of the connectors 8 and data on the positions on the fixing seat 61 that correspond to the respective identification codes are set in advance. In this case, if the identification code of a target cavity 81 is designated, the amount of operation (transport direction and distance for the fixing seat 61) of the linear actuator 62 for moving the target cavity 81 to the end position P4 will be determined with reference to the data on the position of the cavity 81 in the second direction that corresponds to the identification code.

Note that the target cavity 81 is for the place into which the terminal 92 is to be inserted, and is sequentially selected from the plurality of cavities 81 of the plurality of connectors 8 supported by the connector arraying member 80. If, at the end position P4, a plurality of cavities 81 are lined up in a third direction, one of the plurality of cavities 81 lined up in the third direction will serve as the target cavity 81.

As shown in FIG. 2, the connector arraying member transport mechanism 6 can move the connector arraying member 80 in the first direction in a range from a second waiting position A3, at which the entire connector arraying member 80 is away from the end position P4, to a second operation position A4, at which a part of the connector arraying member 80 is located at the end position P4.

As shown in FIG. 2, the direction in which the first waiting position A1 is located with respect to the first operation position A2 is the same as the direction in which the second waiting position A3 is located with respect to the second operation position A4. In the present embodiment, the second waiting position A3 is located in the first direction (positive X-axis direction) with respect to the first waiting position A1.

The connector arraying member 80 for supporting the plurality of connectors 8, that is, a module of the connector arraying member 80 is prepared for, for example, each wiring module 200.

In a process that is performed prior to the process that is performed by the terminal insertion device 100, the plurality of connectors 8 are attached to the connector arraying member 80 that is produced in advance according to the specifications of the shapes of the connectors 8. Then, the module of the connector arraying member 80 is delivered from the place at which the other process was performed to the place of the terminal insertion device 100, and is mounted on the connector arraying member transport mechanism 6.

### Light Sensor

The light sensor 7 is a transmission type optical sensor, and includes a light emitting unit 71 and a light receiving unit 72. The light emitting unit 71 outputs detection light 73 along a plane that is orthogonal to a straight path R0 passing through the start position P0 when viewed in the third direction, which is orthogonal to the first and second directions. The detection light 73 is sheet light extending along a plane.

Note that in the coordinate axes of the drawings, the positive Z-axis direction direction is the third direction. In the present embodiment, the third direction is the vertically upward direction.

The light receiving unit 72 of the light sensor 7 receives the detection light 73. The light sensor 7 is a sensor for detecting an object blocking the detection light 73 by detecting whether or not the light receiving level of the light receiving unit 72 is lower than a preset level. In the terminal insertion device 100, the light sensor 7 detects the front end portion of the terminal 92 of the terminal-attached electric wire 9 that blocks the detection light 73.

### Terminal Insertion Mechanisms

The terminal insertion mechanisms 2 to 5 are mechanisms for inserting a terminal 92 of a terminal-attached electric wire 9 into a target cavity 81 located at the end position P4. The terminal insertion mechanisms 2 to 5 move, while clamping, a part of the end region 900 of the terminal-attached electric wire 9 so as to thereby remove the end region 900 of the terminal-attached electric wire 9 from the wire retaining portion 902 at the start position P0, and insert the terminal 92 of the moved end region 900 of the terminal-attached electric wire 9 into the target cavity 81 located at the end position P4.

Note that in FIG. 2, for convenience, only portions of the terminal insertion mechanisms 2 to 5 that are configured to clamp a part of the end region 900 of the terminal-attached electric wire 9 are schematically illustrated, and illustrations of other portions of the mechanisms are omitted.

The terminal insertion mechanisms 2 to 5 include a first clamping unit 21 serving as a movement wire end holding unit, which will be described later, and a third direction transport mechanism 22 serving as the wire end moving mechanism. The terminal insertion mechanisms 2 to 5 are used as mechanisms for moving and inserting an end of the terminal-attached electric wire 9 into a cavity 81 of a connector 8 via the first clamping unit 21.

### First Clamping Unit-Associated Mechanism

Of the terminal insertion mechanisms 2 to 5, the first clamping unit-associated mechanism 2 is a mechanism for moving the end region 900 from the start position P0 to a predetermined first intermediate position P1 while clamping a part of the end region 900 of the terminal-attached electric wire 9.

The first clamping unit-associated mechanism 2 includes a first clamping unit 21, a third direction transport mechanism 22, and a first direction transport mechanism 23.

The first clamping unit 21 is a mechanism for clamping, at the start position P0, a part of the end region 900 of the terminal-attached electric wire 9 in which the front end of the terminal 92 is directed in the first direction from both sides in the second direction.

The first clamping unit 21 has a pair of first opposing members 211, and a first separating and approximating actuator 212 for bringing the pair of first opposing members 211 close to each other and away from each other in the second direction (Y-axis direction).

Each of the pair of first opposing members 211 has two branched portions branched from the base portion. The branched portions of the pair of first opposing members 211 clamp and support the electric wire 91 of the terminal-attached electric wire 9 at two positions that are located on both sides of the portion clamped by the wire retaining portion 902 (that is, portions of the end of the terminal-attached electric wire 9 that are not included in the portion held by the wire retaining portion 902). The first clamping unit 21 preferably clamps and supports that portion of the end of the terminal-attached electric wire 9 that is located between the portion held by the wire retaining portion 902 and the portion clamped by a pair of clamping units (described later), and here the portions in the positive X-axis direction of the two branched portions of each of the pair of first opposing members 211 clamp and support that portion.

The first separating and approximating actuator 212 brings the pair of first opposing members 211 close to each other or away from each other in the second direction. Accordingly, the first separating and approximating actuator 212 switches the state of the pair of first opposing members 211 to the state in which the electric wire 91 is clamped or to the state in which the clamping of the electric wire 91 is released. The first separating and approximating actuator 212 is, for example, a solenoid actuator, a ball screw-type electric actuator, or the like.

The third direction transport mechanism 22 of the first clamping unit-associated mechanism 2 is a mechanism for moving the first clamping unit 21 in the third direction. Furthermore, the first direction transport mechanism 23 of the first clamping unit-associated mechanism 2 is a mechanism for moving the first clamping unit 21 in the first direction.

The third direction transport mechanism 22 and the first direction transport mechanism 23 move the first clamping unit 21 along a plane that passes through the start position P0 and extends in the first and third directions. Therefore, the first intermediate position P1 is located in the plane that passes through the start position P0 and extends in the first and third directions.

In the present embodiment, the third direction transport mechanism 22 moves the first clamping unit 21 in the third direction while directly supporting it, and the first direction transport mechanism 23 moves the third direction transport mechanism 22 in the first direction while supporting it.

For example, the first direction transport mechanism 23 is provided with a slide supporting portion 231, which supports the third direction transport mechanism 22 so that it can move in the first direction, and a linear actuator 232 for moving the third direction transport mechanism 22 in the third direction. The third direction transport mechanism 22 and the linear actuator 232 are, for example, well-known ball screw-type electric actuators or the like.

While the third direction transport mechanism 22 and the first direction transport mechanism 23 move the end region 900 of the terminal-attached electric wire 9 from the start position P0 to the first intermediate position P1, the first direction transport mechanism 23 moves the end region 900 of the terminal-attached electric wire 9 along the straight path RO. The operations of the third direction transport mechanism 22 and the first direction transport mechanism 23 will be described later in further detail.

Note that the third direction transport mechanism 22 and the first direction transport mechanism 23 of the first clamping unit-associated mechanism 2 serve as examples of a first clamping unit transport mechanism for moving the end region 900 of the terminal-attached electric wire 9 to the first intermediate position P1 by moving the first clamping unit 21.

The third direction transport mechanism 22 is used as a wire end moving mechanism for moving the first clamping unit 21 between a position at which it can hold the end of the terminal-attached electric wire 9 held by the wire retaining portion 902 (lowered position) and another position (lifted position). In particular, the third direction transport mechanism 22 advances and retracts the first clamping unit 21 toward and away from the wire retaining portion 902 in the first direction (Z-axis direction), that is, in a direction that crosses the direction (X-axis direction) in which the terminal-attached electric wire 9 held by the wire retaining portion 902 extends (here, the direction orthogonal to the Z-axis direction). Of course, it is sufficient that the wire end moving mechanism retracts the first clamping unit 21 in a direction orthogonal to the X-axis direction, and the wire end moving mechanism may be inclined in the Z-axis direction.

Furthermore, the first clamping unit-associated mechanism is provided with a terminal correcting unit 1000 that includes a pair of pinching parts 1010 and 1020 for pinching the terminal 92 at the end of the terminal-attached electric wire 9 held by the wire retaining portion 902 so as to correct the orientation of the terminal 92 to a predetermined orientation when the end of the terminal-attached electric wire 9 is transferred from the wire retaining portion 902 to the first clamping unit 21.

The configuration according to the terminal correcting unit 1000 will be described in detail later.

### Second Clamping Unit-Associated Mechanism

Of the terminal insertion mechanisms 2 to 5, the second clamping unit-associated mechanism 3 is a mechanism for taking over the support of the end region 900 of the terminal-attached electric wire 9 at the first intermediate position P1 from the first clamping unit 21. Furthermore, the second clamping unit-associated mechanism 3 temporarily transfers the support of the terminal 92 of the terminal-attached electric wire 9 to the third clamping unit 4, and then hands over the terminal-attached electric wire 9 to the fourth clamping unit-associated mechanism 5.

The second clamping unit-associated mechanism 3 includes a second clamping unit 31, a first direction transport mechanism 32, and a second direction transport mechanism 33.

The second clamping unit 31 clamps, at the first intermediate position P1, a part of the terminal 92 and a part of the electric wire 91 in the end region 900 of the terminal-attached electric wire 9 clamped by the first clamping unit 21 from both sides in the second direction (Y-axis direction).

The second clamping unit 31 then takes over the support of the end region 900 of the terminal-attached electric wire 9 from the first clamping unit 21 at the first intermediate position Pl.

The second clamping unit 31 includes a front second clamping unit 31a and a rear second clamping unit 31b. Each of the front second clamping unit 31a and the rear second clamping unit 31b includes a pair of second opposing members 311, and a second separating and approximating actuator 312 for bringing the pair of second opposing members 311 close to each other and away from each other in the second direction (Y-axis direction).

The pair of second opposing members 311 of the front second clamping unit 31a clamp and support a part of the terminal 92 in the end region 900 of the terminal-attached electric wire 9. On the other hand, the pair of second opposing members 311 of the rear second clamping unit 31b clamp and support a part of the electric wire 91 in the end region 900 of the terminal-attached electric wire 9.

Since the second clamping unit 31 includes the front second clamping unit 31a and the rear second clamping unit 31b, it is possible to perform the operations of clamping and unclamping the terminal 92 of the terminal-attached electric wire 9, and the operations of clamping and unclamping the electric wire 91 of the terminal-attached electric wire 9 clamping, independently.

The second separating and approximating actuators 312 bring the pairs of second opposing members 311 close to each other or away from each other in the second direction. Accordingly, each second separating and approximating actuator 312 switches the state of the pair of second opposing members 311 to the state in which the end region 900 of the terminal-attached electric wire 9 is clamped, or to the state in which the clamping of the end region 900 is released. The second separating and approximating actuators 312 are, for example, solenoid actuators, ball screw-type electric actuators, or the like.

The first direction transport mechanism 32 of the second clamping unit-associated mechanism 3 is a mechanism for moving the second clamping unit 31 in the first direction. Furthermore, the second direction transport mechanism 33 of the second clamping unit-associated mechanism 3 is a mechanism for moving the second clamping unit 31 in the second direction.

The first direction transport mechanism 32 moves the second clamping unit 31 from the first intermediate position P1 to a predetermined second intermediate position P2. Furthermore, the second direction transport mechanism 33 moves the second clamping unit 31 from the second intermediate position P2 to the predetermined third intermediate position P3. Furthermore, the first direction transport mechanism 32 and the second direction transport mechanism 33 move the second clamping unit 31 from the third intermediate position P3 to the first intermediate position P1.

In the present embodiment, the first direction transport mechanism 32 is provided with a slide supporting portion 321, which supports the second clamping unit 31 so that it can move in the first direction, and a linear actuator 322 for moving the slide supporting portion 321 in the first direction.

Furthermore, in the present embodiment, the second direction transport mechanism 33 is provided with a slide supporting portion 331, which supports the second clamping unit 31 and the first direction transport mechanism 32 so that they can move in the second direction, and a linear actuator 332 for moving the slide supporting portion 331 in the second direction.

### Third Clamping Unit

Of the terminal insertion mechanisms 2 to 5, the third clamping unit 4 clamps, at the predetermined second intermediate position P2, a part of the terminal 92 in the end region 900 of the terminal-attached electric wire 9 clamped by the second clamping unit 31 from both sides in the third direction. This third clamping unit 4 temporarily takes over the support of the terminal 92 of the terminal-attached electric wire 9 from the second clamping unit 31, and then hands over the support to the second clamping unit 31.

The third clamping unit 4 has a pair of third opposing members 41, and a third separating and approximating actuator 42 for bringing the pair of third opposing members 41 close to each other and away from each other in the third direction (Z-axis direction). In the present embodiment, the third clamping unit 4 is fixed.

The pair of third opposing members 41 clamp and support a part of the terminal 92 in the end region 900 of the terminal-attached electric wire 9.

The third separating and approximating actuator 42 brings the pair of third opposing members 41 close to each other or away from each other in the third direction. Accordingly, the third separating and approximating actuator 42 switches the state of the pair of third opposing members 41 to the state in which the terminal 92 of the terminal-attached electric wire 9 are clamped, or the state in which the clamping of the terminal 92 is released. The third separating and approximating actuator 42 is, for example, a solenoid actuator, a ball screw-type electric actuator, or the like.

Note that the first direction transport mechanism 32 of the second clamping unit-associated mechanism 3 is an example of a mechanism for changing a positional relationship between the second and third clamping units, the mechanism moving at least one of the second clamping unit 31 and the third clamping unit 4 in the first direction.

In other words, the first direction transport mechanism 32 changes the positional relationship of the terminal 92 of the terminal-attached electric wire 9 clamped by the second clamping unit 31 to the third clamping unit 4 between a first positional relationship and a second positional relationship. The first positional relationship is a positional relationship in which the third clamping unit 4 is separated from the terminal 92 in the first direction. The second positional relationship is a positional relationship in which the terminal 92 is located at a clamping position of the third clamping unit 4.

In the present embodiment, when the end region 900 of the terminal-attached electric wire 9 is located at the first intermediate position P1, the positional relationship between the terminal 92 and the third clamping unit 4 is the first positional relationship. Furthermore, when the end region 900 of the terminal-attached electric wire 9 is located at the second intermediate position P2, the positional relationship between the terminal 92 and the third clamping unit 4 is the second positional relationship.

### Fourth Clamping Unit-Associated Mechanism

Of the terminal insertion mechanisms 2 to 5, the fourth clamping unit-associated mechanism 5 is a mechanism for taking over the support of the end region 900 of the terminal-attached electric wire 9 from the second clamping unit 31 at the predetermined third intermediate position P3. Furthermore, the fourth clamping unit-associated mechanism 5 moves, while clamping, the end region 900 of the terminal-attached electric wire 9 so as to thereby insert the terminal 92 of the terminal-attached electric wire 9 into the cavity 81 of the connector 8 located at the end position P4.

The fourth clamping unit-associated mechanism 5 includes a fourth clamping unit 51, a third direction transport mechanism 52, and a first direction transport mechanism 53.

The fourth clamping unit 51 clamps, at the third intermediate position P3, a part of the terminal 92 and a part of the electric wire 91 in the end region 900 of the terminal-attached electric wire 9 that is clamped by the second clamping unit 31 after the second clamping unit 31 took over the support thereof from the third clamping unit 4. The fourth clamping unit 51 then takes over the support of the end region 900 of the terminal-attached electric wire 9 from the second clamping unit 31 at the third intermediate position P3.

The fourth clamping unit 51 includes a front fourth clamping unit 51a and a rear fourth clamping unit 51b. Each of the front fourth clamping unit 51a and the rear fourth clamping unit 51b has a pair of fourth opposing members 511, and a fourth separating and approximating actuator 512 for bringing the pair of fourth opposing members 511 close to each other and away from each other in the second direction (Y-axis direction).

The pair of fourth opposing members 511 of the front fourth clamping unit 51a clamp and support a part of the terminal 92 in the end region 900 of the terminal-attached electric wire 9. On the other hand, the pair of fourth opposing members 511 of the rear fourth clamping unit 51b clamp and support a part of the electric wire 91 in the end region 900 of the terminal-attached electric wire 9.

Since the fourth clamping unit 51 includes the front fourth clamping unit 51a and the rear fourth clamping unit 51b, it is possible to perform the operations of clamping and unclamping the terminal 92 of the terminal-attached electric wire 9, and the operations of clamping and unclamping the electric wire 91 of the terminal-attached electric wire 9, independently.

The fourth separating and approximating actuators 512 bring the pairs of fourth opposing members 511 close to each other or away from each other in the second direction. Accordingly, each fourth separating and approximating actuator 512 switches the state of the pair of second opposing members 311 to the state in which the end region 900 of the terminal-attached electric wire 9 is clamped, or to the state in which the clamping of the end region 900 is released. The fourth separating and approximating actuators 512 are, for example, solenoid actuators, ball screw-type electric actuators, or the like.

The front fourth clamping unit 51a and the rear fourth clamping unit 51b are insertion wire end holding units that can hold an end of a terminal-attached electric wire 9 when a terminal 92 is inserted into a cavity 81 of a connector 8.

The third direction transport mechanism 52 of the fourth clamping unit-associated mechanism 5 is a mechanism for moving the fourth clamping unit 51 in the third direction. The third direction transport mechanism 52 includes a front third direction transport mechanism 52a for moving the front fourth clamping unit 51a in the third direction, and a rear third direction transport mechanism 52b for moving the rear fourth clamping unit 51b in the third direction.

Since the third direction transport mechanism 52 of the fourth clamping unit-associated mechanism 5 includes the front third direction transport mechanism 52a and the rear third direction transport mechanism 52b, it is possible to perform the operation of moving the front fourth clamping unit 51a in the third direction, and the operation of moving the rear fourth clamping unit 51b in the third direction, independently.

In the fourth clamping unit-associated mechanism 5, the third direction transport mechanism 52 moves the fourth clamping unit 51 in the third direction (the positive Z-axis direction) by a difference in the distance in the third direction between the known third intermediate position P3 and the known position of the target cavity 81 located at the end position P4. Of course, if there is no difference in the distance, the third direction transport mechanism 52 does not move the fourth clamping unit 51.

Furthermore, the first direction transport mechanism 53 of the fourth clamping unit-associated mechanism 5 moves the fourth clamping unit 51 in the first direction (positive X-axis direction) by a distance that corresponds to a sum of a difference in the distance in the first direction between the known third intermediate position P3 and the known position of the entrance of the target cavity 81 located at the end position P4, and the depth of the target cavity 81.

This first direction transport mechanism 53 is an insertion advancing and retracting driving unit for advancing and retracting the front fourth clamping unit 51a and the rear fourth clamping unit 51b, which are the insertion wire end holding units, toward and from the cavity 81.

By the above-described operations of the third direction transport mechanism 52 and the first direction transport mechanism 53, the terminal 92 of the terminal-attached electric wire 9 is moved from the third intermediate position P3, and is inserted into the target cavity 81 that is located at the end position P4.

In the present embodiment, the third direction transport mechanism 52 is provided with the slide supporting portion 321, which supports the second clamping unit 31 so that it can move in the first direction, and the linear actuator 322 for moving the slide supporting portion 321 in the first direction.

In the present embodiment, the third direction transport mechanism 52 moves the fourth clamping unit 51 in the third direction while directly supporting it, and the first direction transport mechanism 53 moves the third direction transport mechanism 52 in the first direction while supporting it.

For example, the first direction transport mechanism 53 is provided with a slide supporting portion 531, which supports the third direction transport mechanism 52 so that is can move in the first direction, and a linear actuator 532 for moving the third direction transport mechanism 52 in the third direction. The third direction transport mechanism 52 and the linear actuator 532 are, for example, well-known ball screw-type electric actuators, or the like.

Note that the third direction transport mechanism 52 and the first direction transport mechanism 53 of the fourth clamping unit-associated mechanism 5 serve as examples of a fourth clamping unit transport mechanism for inserting the terminals 92 of the terminal-attached electric wires 9 into the cavities 81 of the connectors 8 by moving the fourth clamping unit 51.

Furthermore, the second direction transport mechanism 33 of the second clamping unit-associated mechanism 3 serves as an example of a second clamping unit transport mechanism for moving the second clamping unit 31 in the second direction. The second direction transport mechanism 33 moves the second clamping unit 31 between the second intermediate position P2, at which it takes over the support of the terminal 92 from the third clamping unit 4, and the third intermediate position P3, at which it hands over the support of the terminal-attached electric wire 9 to the fourth clamping unit 51.

Note that as shown in FIG. 1, the terminal insertion device 100 is provided also with a wire hook portion 70. The wire hook portion 70 is driven by a not-shown driving mechanism so as to be displaced between the end position P4 and the third intermediate position P3, and hooks to the electric wire 91 of the terminal-attached electric wire 9 whose terminal 92 has already been inserted into the cavity 81 so as to distance the electric wire 91 away from the end position P4. Accordingly, the electric wire 91 protruding from the connector 8 is prevented from disturbing the insertion of the terminal 92 of a new terminal-attached electric wire 9.

### Control Unit

The control unit 10 is a device for controlling the actuators of the wire arraying member transport mechanism 1, the terminal insertion mechanisms 2 to 5, and the connector arraying member transport mechanism 6, with reference to a detection signal of the light sensor 7. Note that in FIG. 2, an illustration of the control unit 10 is omitted.

The control unit 10 is provided with a calculation unit 101, a storage unit 102, and a signal interface 103. The calculation unit 101, the storage unit 102, and the signal interface 103 are electrically connected to each other.

The calculation unit 101 is an element or a circuit that includes a CPU (Central Processing Unit) for executing processing of giving control instructions to the actuators according to control programs stored in advance in the storage unit 102.

The storage unit 102 is a nonvolatile memory that stores the control programs that are to be referenced by the calculation unit 101, and other pieces of data. For example, the storage unit 102 stores, in addition to the control programs, data such as predetermined path transport data, terminal-cavity correspondence data, electric wire position data, and cavity position data.

The predetermined path transport data includes data representing an operation procedure for moving the end region 900 of the terminal-attached electric wire 9 along a predetermined path from the start position P0 to the straight path RO, the operation procedure being performed by the actuator of the first clamping unit-associated mechanism 2. The predetermined path transport data furthermore includes data representing an operation procedure for moving the end region 900 along a predetermined path from the position at which the terminal 92 is detected by the light sensor 7 to the third intermediate position P3 via the first intermediate position P1 and the second intermediate position P2, the operation procedure being performed by the actuator of the second clamping unit-associated mechanism 3.

The terminal-cavity correspondence data is data representing the correspondence relationship between the identification codes of the respective wire retaining portions 902 of the wire arraying member 90 that clamp electric wires 91, and the identification codes of the respective cavities 81 into which the terminals 92 are inserted. The terminal-cavity correspondence data furthermore represents the order of the wire retaining portions 902 that are to be positioned at the start position P0.

The electric wire position data includes data necessary for specifying the respective positions of the wire retaining portions 902 on the wire arraying member 90. In other words, the electric wire position data includes data necessary for specifying the amount of operation of the linear actuator 12 of the wire arraying member transport mechanism 1 when it moves the respective wire retaining portions 902 to the start position P0.

Furthermore, the cavity position data includes data necessary for specifying the positions and depths, in the second direction (Y-axis direction) and the third direction (Z-axis direction), of the cavities 81 of the connectors 8 supported on the connector arraying member 80. In this case, the positions, in the first direction (X-axis direction), of the entrances of the cavities 81 are all the same known positions.

In other words, the data on the positions of the cavities 81 in the second direction that is included in the cavity position data is data necessary for specifying the amount of operation of the linear actuator 62 of the connector arraying member transport mechanism 6 when it moves the cavities 81 of the connectors 8 supported on the connector arraying member 80 to the end position P4.

Furthermore, the data on the positions and depths of the cavities 81 in the third direction that is included in the cavity position data is data necessary for specifying the amounts of operations of the third direction transport mechanism 52 and the first direction transport mechanism 53 of the fourth clamping unit-associated mechanism 5 when they move the terminal 92 of the terminal-attached electric wire 9 from the third intermediate position P3 into the target cavity 81.

The signal interface 103 inputs a detection signal from the light receiving unit 72 of the light sensor 7, and transmits the detection signal to the calculation unit 101. Furthermore, the signal interface 103 inputs control instructions that were given to the actuators by the calculation unit 101, converts the control instructions into driving signals for the actuators, and outputs the resulting driving signals.

### Wiring Module Manufacturing Process

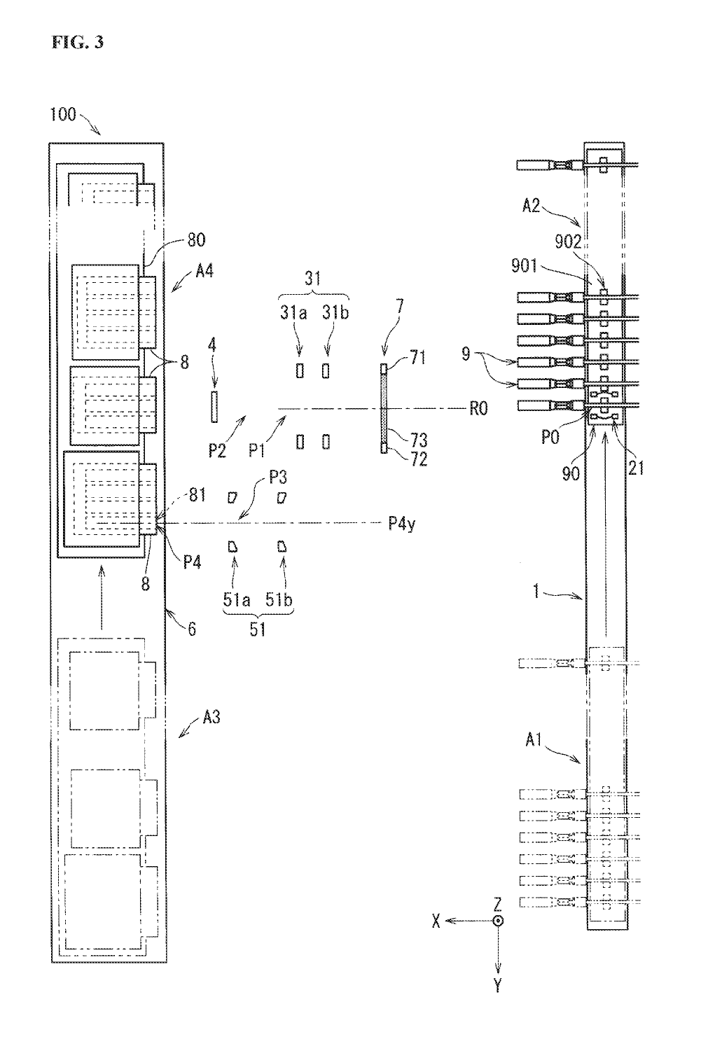

The following will describe an example of the processing that is performed by the terminal insertion device 100 with reference to FIGS. 3 to 12. The terminal insertion device 100 executes, of processes for producing the wiring module 200 including a plurality of terminal-attached electric wires 9 and a plurality of connectors 8 connected to ends thereof, a terminal inserting process for inserting the respective terminals 92 of the terminal-attached electric wires 9 into the cavities 81 of the connectors 8.

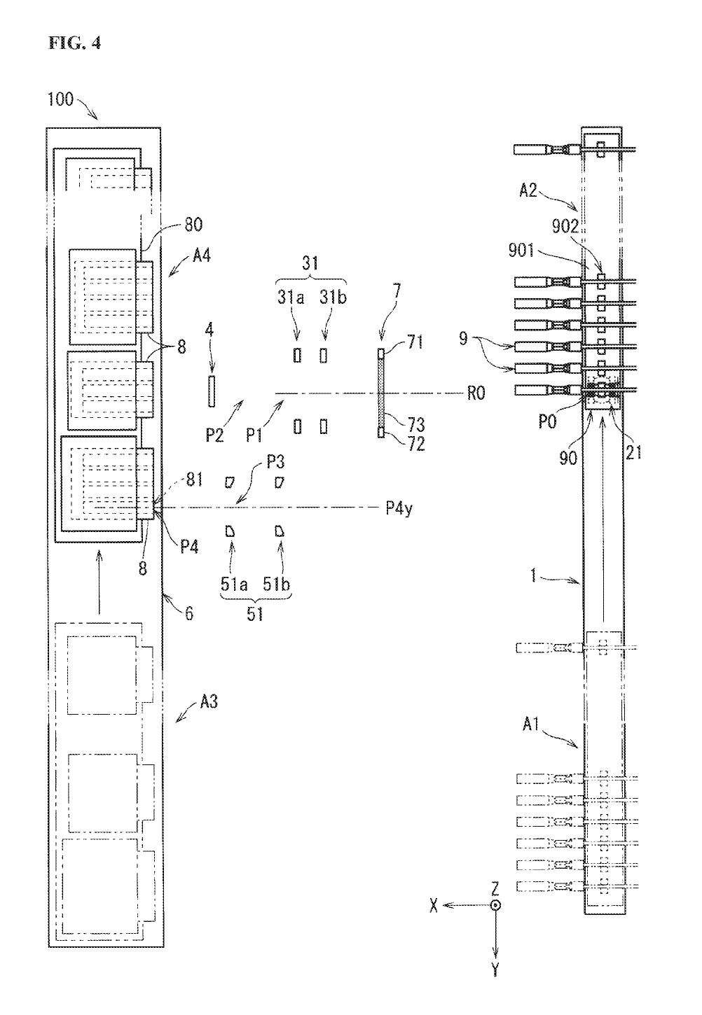

Note that for convenience, in FIGS. 3 to 12, only those portions of the terminal insertion mechanisms 2 to 5 that clamp parts of the end regions 900 of the terminal-attached electric wires 9 are schematically illustrated, and illustrations of other mechanisms are omitted. Furthermore, in FIGS. 4 to 12, illustrations of the wire arraying member transport mechanism 1 and the connector arraying member transport mechanism 6 are omitted.

Furthermore, for convenience, FIGS. 4 to 12 show the first clamping unit 21, the second clamping unit 31, the third clamping unit 4, and the fourth clamping unit 51 that clamp the end region 900 of the terminal-attached electric wire 9 in black, and that are in the state in which the clamping of the end region 900 of the terminal-attached electric wire 9 is released in white.

The terminal inserting process includes a start/end position deciding process, a clamping start process, a first transport primary process, a first transport secondary process, a first transfer process, a second transport process, a second transfer process, a third transport process, a third transfer process, a fourth transport primary process, and a fourth transport secondary process.

Note that the mechanisms that operate in the processes operate in accordance with the control instructions given by the calculation unit 101 executing the control programs stored in the storage unit 102 of the control unit 10. At this time, the calculation unit 101 of the control unit 10 outputs control signals to the mechanisms via the signal interface 103 with reference to various types of data stored in the storage unit 102 and results of detection by the light sensor 7, and thereby lets the mechanisms execute the above-described processes.

Also, prior to the execution of the above-described processes, the module of the wire arraying member 90 is fixed to the fixing seat 11 in a state in which the fixing seat 11 is positioned at the first waiting position Al by the wire arraying member transport mechanism 1. Furthermore, the module of the connector arraying member 80 is fixed to the fixing seat 61 in a state in which the fixing seat 61 is positioned at the second waiting position A3 by the connector arraying member transport mechanism 6.

### Start/End Position Deciding Process

The start/end position deciding process includes a start position deciding process and an end position deciding process.

As shown in FIG. 3, the start position deciding process is a process in which the wire arraying member transport mechanism 1 selectively positions a wire retaining portion 902 of the wire arraying member 90 at the start position P0. In this process, the control unit 10 sequentially specifies the target wire retaining portion 902 to be moved to the start position P0 based on the terminal-cavity correspondence data in the storage unit 102.

Then, the wire arraying member transport mechanism 1 moves the wire arraying member 90 in the second direction, and thereby positions the target wire retaining portion 902 specified by the control unit 10 at the start position P0.

On the other hand, the end position deciding process is a process in which the connector arraying member transport mechanism 6 moves the connector arraying member 80 in the second direction, and thereby selectively positions a cavity 81 of a connector 8 at the end position P4 in the second direction. In this process, the control unit 10 sequentially specifies the target cavity 81 to be moved to the end position P4 based on the terminal-cavity correspondence data in the storage unit 102.

Then, the connector arraying member transport mechanism 6 moves the connector arraying member 80 in the second direction, and thereby positions the target cavity 81 specified by the control unit 10 at the end position P4. Note that if the last target cavity 81 and the current target cavity 81 are lined up in the third direction, the connector arraying member transport mechanism 6 will not move the connector arraying member 80 in this process.

The start position deciding process and the end position deciding process may be performed in parallel, for example. Alternatively, these processes may be performed sequentially.

The start/end position deciding process is executed each time the control unit 10 sequentially specifies a target wire retaining portion 902. Also, each time the start/end position deciding process is executed, the clamping start process, first transport primary process, first transport secondary process, first transfer process, second transport process, second transfer process, third transport process, third transfer process, fourth transport primary process, and fourth transport secondary process, which will be described later, are executed.

The process shown in FIG. 3 is a first start/end position deciding process, and this process serves also as an operation position shift process.

As shown in FIG. 3, the operation position shift process includes a first operation position shift process in which the wire arraying member transport mechanism 1 moves the wire arraying member 90 supporting the end regions 900 of the plurality of terminal-attached electric wires 9 from the first waiting position Al to the first operation position A2.

Furthermore, the operation position shift process includes a second operation position shift process in which the connector arraying member transport mechanism 6 moves the connector arraying member 80 supporting the plurality of connectors 8 from the second waiting position A3 to the second operation position A4.

The first operation position shift process and the second operation position shift process may be performed in parallel, for example. Alternatively, these processes may be performed sequentially.

### Clamping Start Process

As shown in FIG. 4, the clamping start process is a process in which the first clamping unit 21 clamps a part of the end region 900 of the terminal-attached electric wire 9 at the predetermined start position P0 in a state in which the front end of the terminal 92 is directed in the first direction. In the present embodiment, the first clamping unit 21 clamps the electric wire 91 in the end region 900 of the terminal-attached electric wire 9 at two positions from both sides in the second direction.

The two positions of the electric wire 91 at which it is clamped by the first clamping unit 21 are two positions located on both sides of the portion clamped by the wire retaining portion 902. Accordingly, when the first clamping unit 21 clamping the electric wire 91 is moved in the third direction, the electric wire 91 is likely to be removed from the wire retaining portion 902 smoothly without being bent.

### First Transport Primary Process

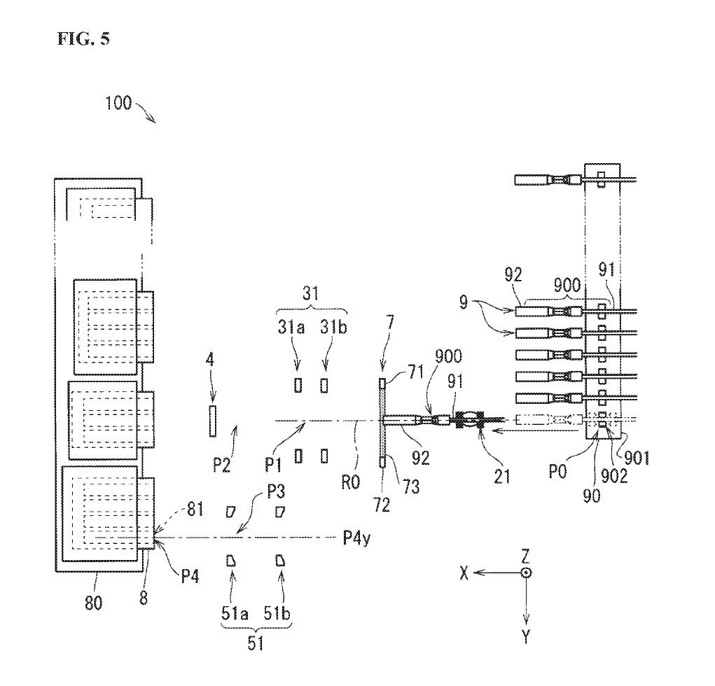

As shown in FIG. 5, the first transport primary process is a process in which the third direction transport mechanism 22 of the first clamping unit-associated mechanism 2 moves the first clamping unit 21 in the third direction by a predetermined distance, and then the first direction transport mechanism 23 of the first clamping unit-associated mechanism 2 moves the first clamping unit 21 along the straight path R0 in the first direction.

In this process, the first direction transport mechanism 23 moves the first clamping unit 21 along the given straight path R0 in the first direction, and if, during this movement, the light sensor 7 detects the front end portion of the terminal 92, the process executed by the first direction transport mechanism 23 and the third direction transport mechanism 22 advances to the first transport secondary process that follows.

For example, in this process, the first direction transport mechanism 23 of the first clamping unit-associated mechanism 2 moves the first clamping unit 21 along the given straight path R0 by a predetermined first distance with a first speed. Here, the first distance is set in a range in which the terminals 92 do not reach the detection light 73 regardless of the variation in the initial positions of the terminal-attached electric wires 9. Then, the first direction transport mechanism 23 moves the first clamping unit 21 along the given straight path R0 with a second speed that is lower than the first speed, until the light sensor 7 detects the front end portion of the terminal 92.

The above-described operation prevents an error in positioning of the terminal 92 from becoming too large to ignore due to a delay of feedback control for controlling the first direction transport mechanism 23 according to a result of detection by the light sensor 7. Furthermore, the above-described operation accelerates the speed of the transport of the terminal-attached electric wire 9 while suppressing the error in positioning of the terminal 92, resulting in a reduction in an execution time of the process.

Note that the process in which the light sensor 7 detects an object (the front end portion of the terminal 92) that blocks the detection light 73 is executed while at least the first transport primary process is executed.

### First Transport Secondary Process

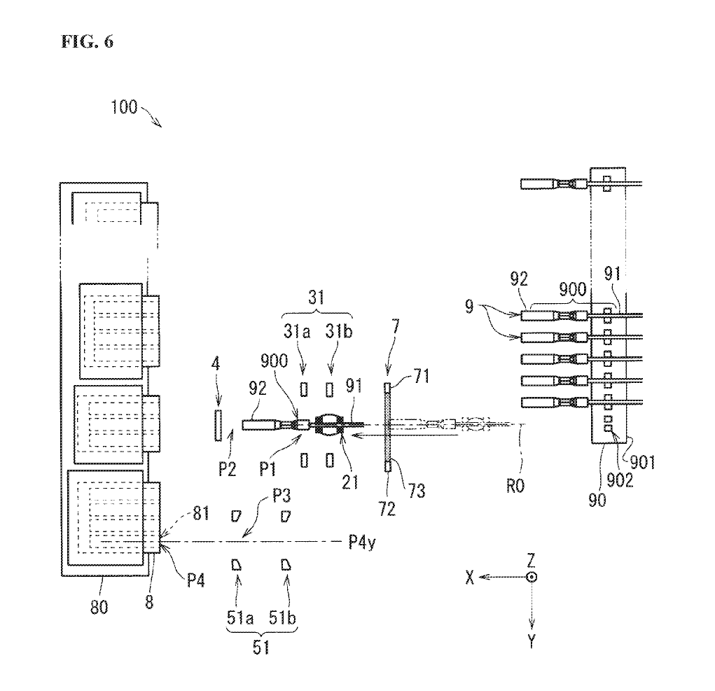

As shown in FIG. 6, the first transport secondary process is a process in which the first direction transport mechanism 23 of the first clamping unit-associated mechanism 2 moves the first clamping unit 21 along the straight path R0 in the first direction by a predetermined distance from the point in time at which the light sensor 7 detects the terminal 92, and then the third direction transport mechanism 22 of the first clamping unit-associated mechanism 2 moves the first clamping unit 21 in a direction opposite to the third direction (the negative Z-axis direction) by a predetermined distance. By this process, the end region 900 of the terminal-attached electric wire 9 is moved to the first intermediate position P1.

### First Transfer Process

As shown in FIG. 7, the first transfer process is a process in which the second clamping unit 31 clamps, at the first intermediate position P1, a part of the terminal 92 and a part of the electric wire 91 in the end region 900 of the terminal-attached electric wire 9 clamped by the first clamping unit 21 from both sides in the second direction.

Furthermore, in this process, the first clamping unit 21 releases the clamping of the electric wire 91. Accordingly, the second clamping unit 31 takes over the support of the terminal-attached electric wire 9 from the first clamping unit 21.

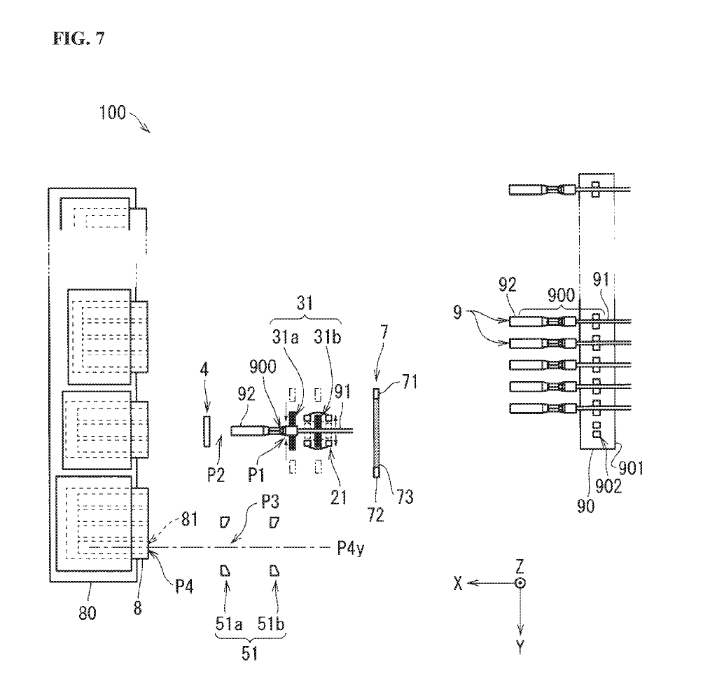

As shown in FIG. 8, the second transport process is a process in which the first direction transport mechanism 32 of the second clamping unit-associated mechanism 3 moves the second clamping unit 31 in the first direction by a predetermined distance. In this process, the first direction transport mechanism 32 moves the end region 900 of the terminal-attached electric wire 9 from the first intermediate position P1, which is away from the third clamping unit 4, to the second intermediate position P2, at which the third clamping unit 4 performs clamping.

### Second Transfer Process

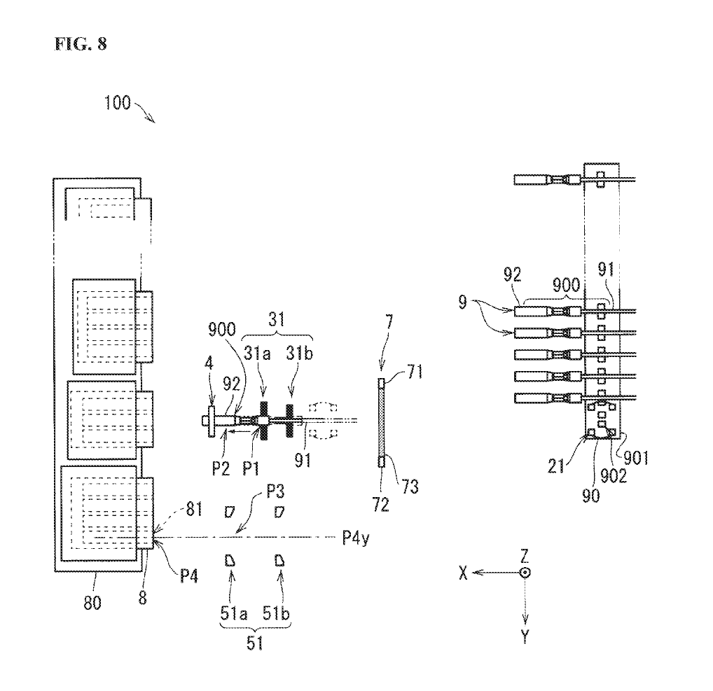

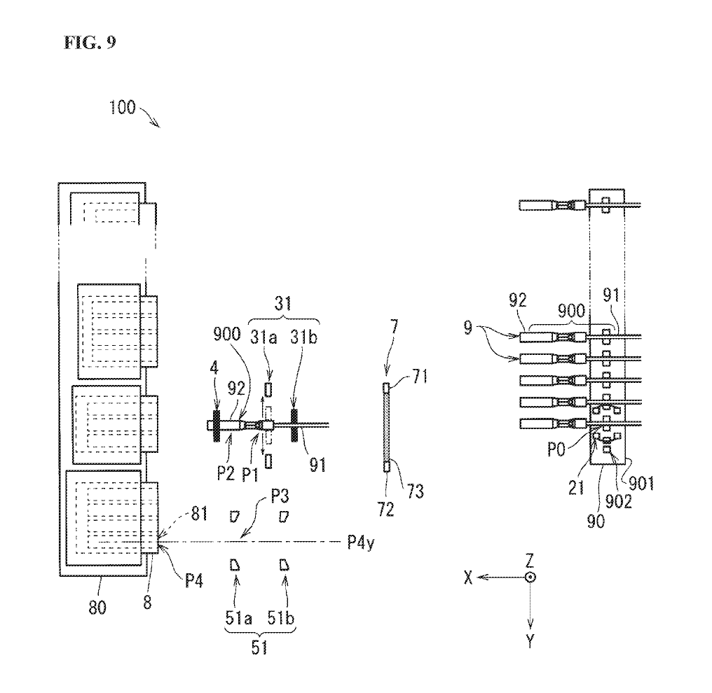

As shown in FIG. 9, the second transfer process is a process in which the third clamping unit 4 temporarily clamps, at the second intermediate position P2, a part of the terminal 92 in the end region 900 of the terminal-attached electric wire 9 clamped by the second clamping unit 31 from both sides in the third direction.

Furthermore, in this process, the front second clamping unit 31a temporarily releases the clamping of the terminal 92 when the third clamping unit 4 clamps the terminal 92, and again clamps the terminal 92. In other words, the third clamping unit 4 temporarily takes over the support of the terminal 92 of the terminal-attached electric wire 9 from the second clamping unit 31, and then hands over the support to the second clamping unit 31.

Note that in this process, it is also conceivable that, like the front second clamping unit 31a, the rear second clamping unit 31b temporary releases the clamping of the electric wire 91 when the third clamping unit 4 clamps the terminal 92, and then again clamps the electric wire 91.

### Third Transport Process

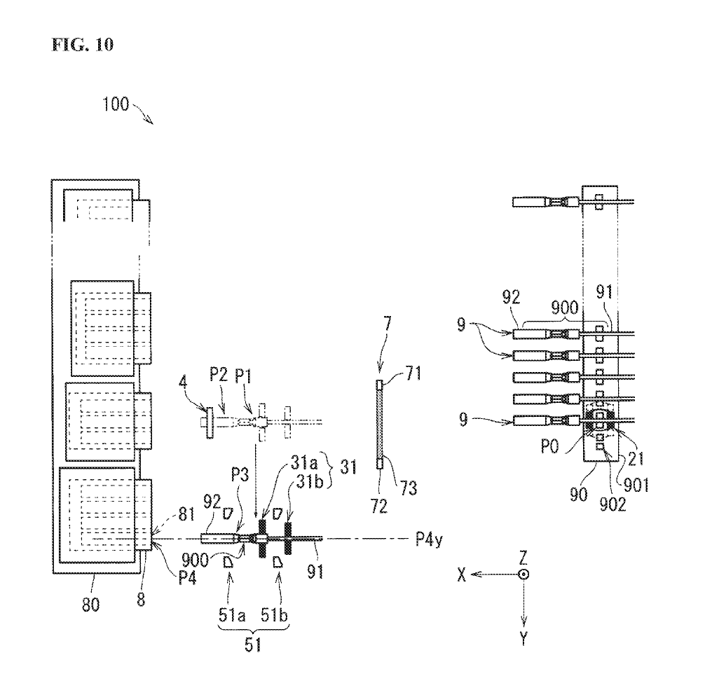

As shown in FIG. 10, the third transport process is a process in which the second direction transport mechanism 33 of the second clamping unit-associated mechanism 3 moves the second clamping unit 31 in the second direction by a predetermined distance. By this process, the second direction transport mechanism 33 moves the second clamping unit 31 from the given second intermediate position P2 to the given third intermediate position P3. As described above, the second intermediate position P2 is a position at which the second clamping unit 31 takes over the support of the terminal 92 from the third clamping unit 4, and the third intermediate position P3 is a position at which the second clamping unit 31 hands over the support of the terminal-attached electric wire 9 to the fourth clamping unit 51.

### Third Transfer Process

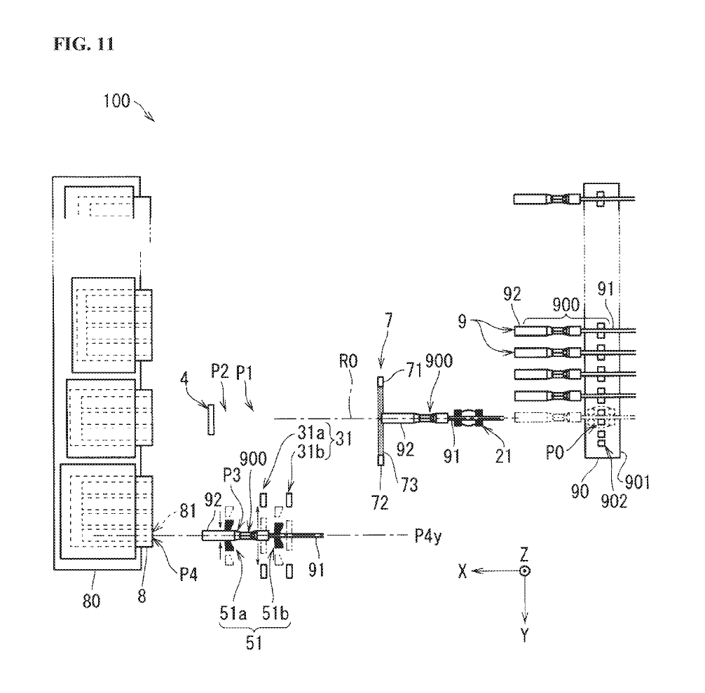

As shown in FIG. 11, the third transfer process is a process in which the fourth clamping unit 51 clamps, at the third intermediate position P3, a part of the terminal 92 and a part of the electric wire 91 in the end region 900 of the terminal-attached electric wire 9 that is clamped by the second clamping unit 31 after the second clamping unit 31 took over the support thereof from the third clamping unit 4.

Furthermore, in this process, the second clamping unit 31 releases the clamping of the end region 900 of the terminal-attached electric wire 9 when the fourth clamping unit 51 clamps the end region 900. Accordingly, the fourth clamping unit 51 takes over the support of the terminal-attached electric wire 9 from the second clamping unit 31.

### Fourth Transport Primary Process

As shown in FIG. 12, the fourth transport primary process is a process in which the third direction transport mechanism 52 and the first direction transport mechanism 53 of the fourth clamping unit-associated mechanism 5 moves the front end portion of the terminal 92 of the terminal-attached electric wire 9 from the third intermediate position P3 into the cavity 81 at the end position P4 by moving the fourth clamping unit 51.

In this process, the third direction transport mechanism 52 moves the fourth clamping unit 51 in the third direction (the positive Z-axis direction) by a difference in the distance in the third direction between the known third intermediate position P3 and the known position of the target cavity 81. Of course, if there is no difference in the distance, the third direction transport mechanism 52 does not move the fourth clamping unit 51.

Furthermore, in this process, the first direction transport mechanism 53 of the fourth clamping unit-associated mechanism 5 moves the fourth clamping unit 51 in the first direction (positive X-axis direction) by a distance that corresponds to a difference in the distance in the first direction between the known third intermediate position P3 and the known position of the entrance of the target cavity 81 located at the end position P4. Accordingly, the front end portion of the terminal 92 is inserted into the target cavity 81.

As described above, in the fourth transport primary process, the third direction transport mechanism 52 and the first direction transport mechanism 53 of the fourth clamping unit-associated mechanism 5 moves the fourth clamping unit 51, according to the moving procedure that is defined based on the comparison between the third intermediate position P3, at which the fourth clamping unit 51 took over the support of the terminal-attached electric wire 9 from the second clamping unit 31, and the preset position of the corresponding cavity 81 of the connector 8.

### Fourth Transport Secondary Process

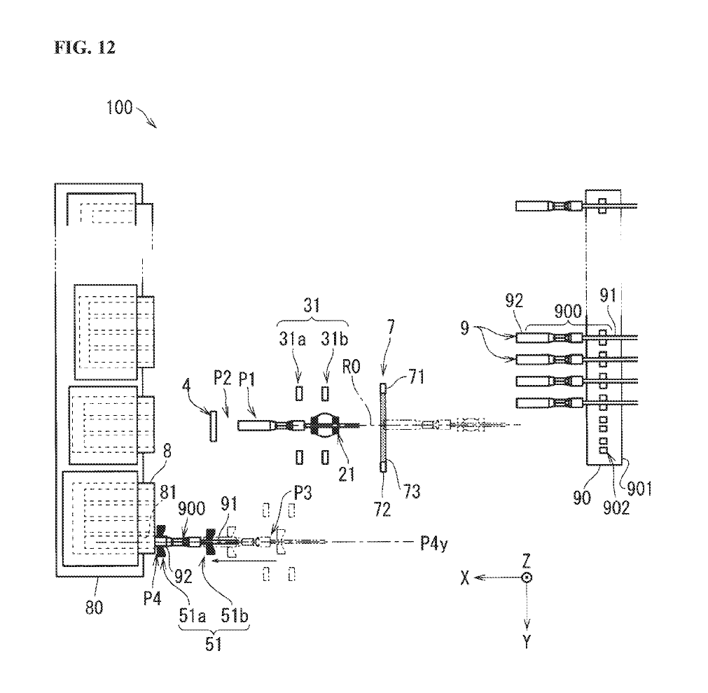

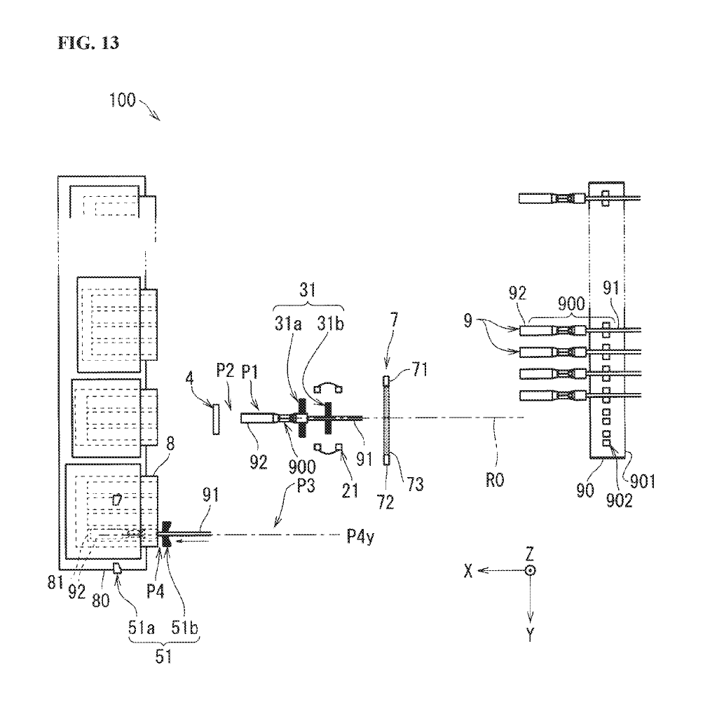

As shown in FIG. 13, the fourth transport secondary process is a process in which the first direction transport mechanism 53 of the fourth clamping unit-associated mechanism 5 further moves the rear fourth clamping unit 51b in the first direction by a distance that corresponds to the depth of the target cavity 81 while the rear fourth clamping unit 51b clamps the electric wire 91 of the end region 900.

In this process, the front fourth clamping unit 51a releases the clamping of the terminal 92, and the front third direction transport mechanism 52a of the fourth clamping unit-associated mechanism 5 moves the front fourth clamping unit 51a in the third direction to the position at which it does not interfere with the connector 8.

By the terminal insertion device 100 executing the foregoing processes, one terminal 92 of a terminal-attached electric wire 9 is inserted into a cavity 81 of a connector 8. Then, the terminal insertion device 100 repeatedly executes the foregoing processes until the insertion of terminals 92 into the cavities 81 of the plurality of connectors 8 supported on the connector arraying member 80 is completed.

When the insertion of the terminals 92 into the cavities 81 of the plurality of connectors 8 supported on the connector arraying member 80 is completed, the connector arraying member transport mechanism 6 moves the connector arraying member 80 from the second operation position A4 to the second waiting position A3. Then, the wire arraying member transport mechanism 1 moves the wire arraying member 90 from the first operation position A2 to the first waiting position A1.

Then, at the first waiting position A1 and the second waiting position A3, the wire arraying member 90 and the connector arraying member 80 are each replaced. The connector arraying member 80 that is removed at the second waiting position A3 from the connector arraying member transport mechanism 6 supports the plurality of connectors 8 all together in a state in which the terminals 92 of the terminal-attached electric wire 9 are inserted thereinto, the plurality of connectors 8 constituting one wire harness or one sub (partial) wire harness.

The connector arraying member 80 that is removed at the second waiting position A3 is delivered to the position of the next process while supporting the plurality of connectors 8 into which the terminals 92 of the terminal-attached electric wires 9 are inserted.

By repeating the foregoing processes, a wiring module 200 is produced that includes a plurality of terminal-attached electric wires 9 and a plurality of connectors 8, and in which the terminals 92 of the plurality of terminal-attached electric wires 9 are integrated with the cavities 81 of the connectors 8 while being inserted thereinto, as shown in FIG. 15.

### Details of Terminal Correction

In the present terminal insertion device 100, the light sensor 7 detects that the front end portion of the terminal 92 of the terminal-attached electric wire 9 moving along the given straight path R0 in the first direction has reached the position of the detection light 73. Then, the end region 900 of the terminal-attached electric wire 9 further moves in the first direction by a predetermined distance from the position at which the light sensor 7 has detected the terminals 92, and reaches the first intermediate position P1. Accordingly, first direction components of the variation in the position of the terminal 92 at the start position P0 are cancelled out at the point in time at which the end region 900 has reached the first intermediate position P1.

Furthermore, the second clamping unit 31 that is to take over the support of the terminal-attached electric wire 9 clamps a part of the terminal 92 and a part of the electric wire 91 in the end region 900 of the terminal-attached electric wire 9 from both sides in the second direction. Accordingly, second direction components of the variation in the position of the terminal 92 at the start position P0 are cancelled out at the point in time at which the second clamping unit 31 has taken over the support of the terminal-attached electric wire 9.

Furthermore, the third clamping unit 4 that is to temporarily take over the support of the terminal 92 of the terminal-attached electric wire 9 clamps a part of the terminal 92 of the terminal-attached electric wire 9 from both sides in the third direction. Accordingly, third direction components of the variation in the position of the terminal 92 at the start position P0 are cancelled out at the point in time at which the third clamping unit has taken over the support of the terminal.

After the variations in the position of the terminal 92 have been cancelled out in the above-described manner, the rear fourth clamping unit 51 takes over the support of the end region 900 of the terminal-attached electric wire 9 from the second clamping unit 31, and moves according to the moving procedure that is defined based on the comparison between the third intermediate position P3, at which the fourth clamping unit 51 took over the support, and the position of the preset cavity 81 of the connector 8.

However, even with the above-described procedure, it is also conceivable that the terminal 92 is rotated about its axis with respect to the fourth clamping unit 51 (hereinafter, this state is referred to as “rolled state”).

In such a case, if it is attempt to insert the terminal 92 into the cavity 81 of the connector 8, the terminal 92 may be caught on a lance or the like of the cavity 81.

Hereinafter, a description will be given with focus on the configuration for correcting the orientation of the terminal 92 in order to solve the rolling of the terminal 92.

FIG. 16 is a perspective view schematically illustrating the terminal correcting unit 1000 included in the first clamping unit-associated mechanism.

The terminal correcting unit 1000 is provided with a pair of pinching parts 1010 and 1020 for pinching the terminal 92 in order to correct the orientation of a terminal 92 at an end of the terminal-attached electric wire 9 held by the first clamping unit 21 to a predetermined orientation when the end of the terminal-attached electric wire 9 is transferred from the wire retaining portion 902 to the first clamping unit 21.

The pinching part 1020, which is one of the pair of pinching parts 1010 and 1020, is supported so as to be movable together with the first clamping unit 21, whereas the other pinching part 1010 is fixed and supported.

More specifically, the pinching part 1010 includes a receiving edge portion 1011 extending in a direction that is orthogonal to the direction (X-axis direction) in which the terminal-attached electric wire 9 supported by the wire retaining portion 902 extends, and the direction (Z-axis direction) in which the first clamping unit 21 is advanced and retracted toward and away from the wire retaining portion 902, the receiving edge portion 1011 facing the first clamping unit 21 side. Here, the pinching part 1010 is formed in a shape in which a square-shaped metal plate is bent in an L shape, and one side of the bent portion is fixed to the portion serving as a main portion or the like of the present device by screwing or the like. The other side of the bent portion of the pinching part 1010 is in an upward orientation. In the fixed state, the receiving edge portion 1011, which serves as an upper end portion of the pinching part 1010, is arranged at about the same height as the downward-facing portion of the conductor-crimped part 92a of the terminal 92 at the end of the terminal-attached electric wire 9 held by the wire retaining portion 902. Accordingly, the conductor-crimped part 92a of the terminal 92 at the end of the terminal-attached electric wire 9 held by the wire retaining portion 902 is supported by the receiving edge portion 1011 from below. However, it is also possible that a gap (preferably, a small gap) is provided between the conductor-crimped part 92a and the receiving edge portion 1011.

The pinching part 1020 includes a pressing edge portion 1021 that extends in a direction that is orthogonal to the direction (X-axis direction) in which the terminal-attached electric wire 9 supported by the wire retaining portion 902 extends, and the direction (Z-axis direction) in which the first clamping unit 21 is advanced and retracted toward and away from the wire retaining portion 902, the pressing edge portion 1021 facing the wire retaining portion 902 side. Here, an elongated band-shaped metal plate 1020B is bent at two positions in an L shape in different directions, and one end portion 1020Ba thereof is arranged on a side (in the positive X-axis direction) of the first separating and approximating actuator 212 that faces the front end portion side of the terminal 92. Furthermore, the other end portion of the metal plate is in a downward orientation, and the lower edge portion thereof serves as a pressing edge portion 1021 that faces the receiving edge portion 1011 at a distance. The portion of the metal plate that includes the pressing edge portion 1021 is used as the pinching part 1020 for pinching the terminal 92 with the pinching part 1010. The position of the pinching part 1020 is set to a position at which a gap between the pinching part 1010 and the pinching part 1020 can be smaller than the thickness of the conductor-crimped part 92a (thickness between the bottom and the opposite portion) in a state in which the first clamping unit 21 is lowered so as to receive the terminal-attached electric wire 9 held by the wire retaining portion 902.

Furthermore, the intermediate portion of the bent portions of the metal plate extends in an orientation orthogonal to the direction (Z-axis direction) in which the pinching part 1020 moves. The metal plate itself is an elastically deformable plate material, and thus by the intermediate portion of the metal plate and the bent portions on both sides thereof elastically deforming, the pinching part 1020 is supported so as to be displaceable in the clamping direction (Z-axis direction). In other words, the intermediate portion of the metal plate is an elastic supporting part 1030 that supports the pinching part 1020 so that it is displaceable in the clamping direction.

Also, when the third direction transport mechanism 22 moves the first clamping unit 21 toward the wire retaining portion 902, the pinching part 1020 is moved, together with the first clamping unit 21, close to the wire retaining portion 902, and the conductor-crimped part 92a of the terminal 92 will be pinched between the pair of pinching parts 1010 and 1020.

Since, at this time, the pinching part 1020 is displaceably supported by the elastic supporting part 1030, the pinching part 1020 is displaced in a direction in which it moves away from the pinching part 1010 even if the gap between the pair of pinching parts 1010 and 1020 is smaller than the thickness of the conductor-crimped part 92a, making it possible to pinch the conductor-crimped part 92a between the pair of pinching parts 1010 and 1020, and to prevent the conductor-crimped part 92a from being subjected to application of an excessive force.

Note that it is sufficient that at least one of the pair of pinching parts 1010 and 1020 is supported by the elastic supporting part so as to be movable in the pinching direction. Accordingly, an elastic supporting part for supporting the pinching part 1010 so that it is movable in the pinching direction may be provided, in addition to or instead of the elastic supporting part 1030 for supporting the pinching part 1020 so that it is elastically deformable.

Furthermore, in addition to the above-described configuration, the elastic supporting part may have a configuration for supporting the pinching part so that it is movable, with an elastic material such as a coil spring or a rubber, or the like.

The operation of the terminal correcting unit 1000 will be described below.

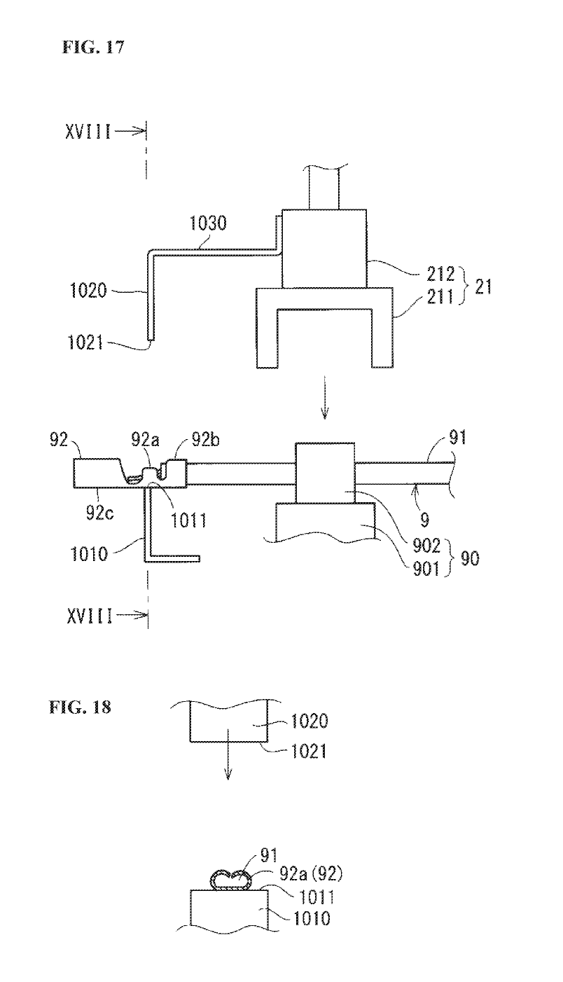

That is, in the first clamping processing, before the first clamping unit 21 clamps the end of the terminal-attached electric wire 9 as shown in FIGS. 17 and 18, the end of the terminal-attached electric wire 9 is supported by the wire retaining portion 902, and the conductor-crimped part 92a of the terminal 92 is arranged on the receiving edge portion 1011 of the pinching part 1010. Furthermore, the first clamping unit 21 is located above and away from the wire retaining portion 902, and the pressing edge portion 1021 of the pinching part 1020 is also located above and away from the conductor-crimped part 92a of the receiving edge portion 1011. Furthermore, in this state, the pair of first opposing members 211 of the first clamping unit 21 are open.

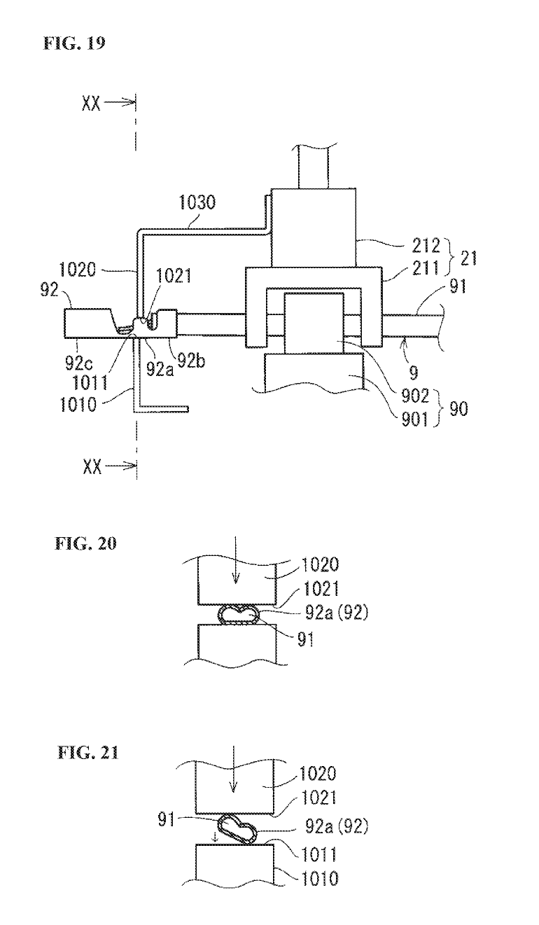

From this state, as shown in FIGS. 19 and 20, the first clamping unit 21 is lowered toward the wire retaining portion 902 by the third direction transport mechanism 22, and reaches a position at which the end of the terminal-attached electric wire 9 can be clamped between the pair of first opposing members 211. Accordingly, the pinching part 1020 is also lowered, and the conductor-crimped part 92a of the terminal 92 is pinched between the receiving edge portion 1011 of the pinching part 1010 and the pressing edge portion 1021 of the pinching part 1020.

At this time, if the terminal 92 is rolled as shown in FIG. 21, the conductor-crimped part 92a of the terminal 92 will be pinched between the pair of pinching parts 1010 and 1020, the orientation of the terminal 92 will be corrected so that the direction of the flat part thereof extends is orthogonal to the direction in which the pair of pinching parts 1010 and 1020 pinch the terminal 92, and the rolling will be resolved.

In this state, the pair of first opposing members 211 of the first clamping unit 21 get close to each other, the portion of the end of the terminal-attached electric wire 9 that is not included in the portion held by the wire retaining portion 902, in particular, the portion between the wire retaining portion 902 and the pair of pinching parts 1010 and 1020. Accordingly, in the state in which the rolling of the terminal 92 is resolved, the end of the terminal-attached electric wire 9 will be held by the first clamping unit 21.

The end of the terminal-attached electric wire 9 in which the rolling of the terminal 92 is thus resolved is transferred to the fourth clamping unit 51 of the fourth clamping unit-associated mechanism 5 via the second clamping unit-associated mechanism 3 or the like, and is inserted into the cavity 81 of the connector 8 by the fourth clamping unit 51. Note that in the transfer operation at the time of transporting the end of the terminal-attached electric wire 9, a configuration is such that the mechanism to which the transfer is taken over holds the end of the terminal-attached electric wire 9 while the mechanism for performing the transfer holds the end of the terminal-attached electric wire 9, and then the mechanism for performing the transfer releases the holding of the end of the terminal-attached electric wire 9, and thus the transport is performed basically in a state in which the orientation of the terminal 92 is corrected by the terminal correcting unit 1000.

According to the thus configured terminal insertion device 100 and method of manufacturing the wiring module 200, when the end of the terminal-attached electric wire 9 is transferred from the wire retaining portion 902 to the first clamping unit 21, the terminal 92 is pinched between the pair of pinching parts 1010 and 1020 so that the orientation of the terminal 92 at the end of the terminal-attached electric wire 9 held by the wire retaining portion 902 is corrected to a predetermined orientation, and thus the terminal 92 can be held by the first clamping unit 21 preferably in a predetermined orientation.

In particular, since the orientation of the terminal 92 is corrected when the end of the terminal-attached electric wire 9 is transferred, the correction can be performed without performing the operation of releasing the holding of the end of the terminal-attached electric wire 9 specifically for the correction, making prompt processing possible.

Furthermore, since the pinching part 1020 is displaceably supported by the elastic supporting part 1030, it is possible to pinch the terminal 92 while suppressing the excessive force to be applied to the terminal 92, making it possible to prevent the deformation of the terminal 92.

Furthermore, since the pinching part 1020 is supported so as to be movable together with the first clamping unit 21, and the pinching part 1020 pinches the terminal 92 with the pinching part 1010 by the operation in which the first clamping unit 21 moves to the wire retaining portion 902, the correction in which the rolling of the terminal 92 is resolved is possible with a simple configuration without providing a driving mechanism specific for clamping.

Of course, the pair of pinching units may also be moved close to each other or away from each other by a specific driving mechanism, and may pinch the terminal 92 at the timing at which the terminal-attached electric wire 9 is transferred.

Furthermore, since the pair of pinching parts 1010 and 1020 pinch the conductor-crimped part 92a of the terminal 92, it is possible to efficiently prevent the breakage of the terminal 92. That is, since the conductor-crimped part 92a and the coating-crimped part 92b of the terminal 92 are crimped to the vicinity of the conductor or the insulating coating of the electric wire 9, they are deformed with more difficulty than the connection part 92c and the like. Particularly, the conductor-crimped part 92b is deformed with more difficulty because it is crimped to the relative hard conductor. Therefore, it is possible to correct the orientation of the terminal 92 while efficiently preventing the breakage of the terminal 92.

Of course, the pair of pinching units may pinch the coating-crimped part 92b, the connection part 92c, or the portion therebetween, for example. In other words, by pinching the portion of the terminal 92 that has a non-circular cross section, it is possible to perform the correction in which the rolling of the terminal 92 is resolved.

Moreover, since the present terminal processing device can serve as a terminal insertion device, and can insert the corrected terminal 92 into the cavity 81 of the connector 8, it is possible to prevent an error in insertion of the terminal 92.

Note that the position into which the terminal correcting unit 1000 is included is not limited to the above-described example, and may be a position at which transfer from the first clamping unit 21 to the second clamping unit 31 is performed, or the like. In other words, the terminal correcting unit 1000 may be included at any position at which the end of the terminal-attached electric wire 9 is to be transferred.

Although the present invention has been described in detail so far, the description above is exemplary in all aspects, and the present invention is not limited to this. A variety of modifications that are not exemplified can be construed as not departing from the scope of the present invention.

### LIST OF REFERENCE NUMERALS

100 Terminal insertion device

1000 Terminal correcting unit

1010, 1020 Pinching unit

1030 Elastic supporting part

2 First clamping unit-associated mechanism

200 Wiring module

21 First clamping unit

211 First opposing member

212 First separating and approximating actuator

22 Third direction transport mechanism

3 Second clamping unit-associated mechanism

5 Fourth clamping unit-associated mechanism

51 Fourth clamping unit

52 Third direction transport mechanism

53 First direction transport mechanism

6 Connector arraying member transport mechanism

61 Fixing seat

8 Connector

81 Cavity

9 Terminal-attached electric wire

9 Electric wire

92 Terminal

92a Conductor-crimped part

1. An electric wire-processing device for holding and moving a terminal at an end of a terminal-attached electric wire, comprising:
a wire end holder that holds the end of the terminal-attached electric wire;
a movement wire end holder that holds a portion of the end of the terminal-attached electric wire that is not included in the portion held by the wire end holder;
a wire end mover that moves the movement wire end holder between a position at which the movement wire end holder can hold the end of the terminal-attached electric wire held by the wire end holder, and another position; and
a terminal corrector including a pair of pinching parts that pinch the terminal, the pair of pinching parts pinching the terminal at the end of the terminal-attached electric wire held by the wire end holder so that the orientation of the terminal is corrected to a predetermined orientation when the end of the terminal-attached electric wire is transferred from the wire end holder to the movement wire end holder,
wherein one of the pair of pinching parts of the terminal corrector is supported so as to be movable together with the movement wire end holder, and
when the movement wire end holder is moved toward the wire end holder by the wire end mover said one of the air of pinching parts approaches the wire end holder, so that the terminal is pinched between the pair of pinching parts.

2. The electric wire processing device according to claim 1,
wherein the pair of pinching parts pinch a conductor-crimped part, which is crimped to a conductor of the electric wire, of the terminal.

3. The electric wire processing device according to claim 1,
wherein the terminal corrector includes an elastic supporting part that supports at least one of the pair of pinching parts so that that pinching part is displaceable with respect to a direction in which the pair of pinching parts perform pinching.

4. (canceled)

5. The electric wire processing device according to claim 1, further comprising:
a connector support that holds a connector;
a terminal inserter including the movement wire end holder and the wire end mover moving, the terminal inserter transporting and inserting the end of the terminal-attached electric wire into a cavity of the connector via the movement wire end holder.

6. A wiring module production method in which a terminal at an end of a terminal-attached electric wire is inserted into a cavity of a connector, comprising:
holding the end of the terminal-attached electric wire with a wire end holder;
pinching, with a pair of pinching parts, the terminal at the end of the terminal-attached electric wire held, and correcting the orientation of the terminal to a predetermined orientation;
holding a portion of the terminal at the end of the terminal-attached electric wire that is not included in the portion held by the wire end holder while the terminal is pinched by the pair of pinching parts, and transferring the end of the terminal-attached electric wire from the wire end holder to a movement wire end holder; and
inserting the end of the terminal-attached electric wire held in this orientation into the cavity of the connector,
wherein one of the pair of pinching parts is supported so as to be movable together with the movement wire end holder, and
when the movement wire end holder is moved toward the wire end holder, said one of the pair of pinching parts approaches the wire end holder, so that the terminal is pinched between the pair of pinching parts.
